(19) United States
(12) Patent Application Publication
(10) Pub. No.: US 2023/0002525 A1
(43) Pub. Date: Jan. 5, 2023

(54) Solution Polymerization Process for Making High-Density Polyethylene with Long-Chain Branching

(71) Applicant: ExxonMobil Chemical Patents Inc., Baytown, TX (US)

(72) Inventors: Gabor KISS, Hampton, NJ (US); Thomas SUN, Clinton, NJ (US); Johannes M. SOULAGES, Basking Ridge, NJ (US); Kanmi MAO, Basking Ridge, NJ (US)

(21) Appl. No.: 17/756,524

(22) PCT Filed: Nov. 17, 2020
(86) PCT No.: PCT/US2020/060891

§ 371 Date: May 26, 2022

Related U.S. Application Data
(60) Provisional application No. 62/949,274, filed on Dec. 17, 2019.

(51) Int. Cl. C08F 210/16; C08F 110/02

(52) U.S. Cl. CPC C08F 210/16; C08F 110/02

(57) ABSTRACT

A polymerization process includes contacting an ethylene feed containing ethylene monomers with a catalyst feed containing a hafnium-based or zirconium-based single-site catalyst in a solution so as to polymerize the ethylene monomers into long-chain branched high density polyethylene having on average a long-chain branch/polymer chain less than 10 and greater than 0.25. A polymerization composition includes ethylene; a hafnium-based or zirconium-based single-site catalyst; and a long-chain branched high density polyethylene polymerization product, where the long-chain branched high density polyethylene has on average a long-chain branch/polymer chain less than 10 and greater than 0.25; and where at least one of the ethylene, the catalyst, and the product is in solution.

### CROSS-REFERENCE TO RELATED APPLICATION

This application claims the benefit of U.S. Provisional Application 62/949,274, filed Dec. 17, 2019, entitled “Solution Polymerization Process For Making High-Density Polyethylene With Long-Chain Branching”, the entirety of which is incorporated by reference, herein.

### FIELD

This disclosure relates to polymerization solution processes for making and polymerization solution compositions containing high density-polyethylene with long-chain branching.

### BACKGROUND

To reduce processing cost, polyethylene melt viscosity is desirably low during the high-shear conditions of melt-processing. However, if the polyethylene also has low melt-viscosity under low- or no-shear conditions, it may present an issue due to the ready deformation of the still hot article as it leaves the hot zone of the melt processing equipment. It would therefore be desirable to make polyethylene (PE) that has low melt viscosity under high shear, yet has high viscosity under low- or no-shear conditions. These properties are of use in several applications, such as, for example, foam, roofing membrane, and film.

Polyolefins typically show varying shear-thinning phenomena. Some of them, like low-density polyethylene (LDPE), have high degree of shear thinning, thus is advantageous from a processing cost perspective. It also has good green strength, i.e., could preserve its shape as it leaves the hot high-shear zone of the melt-processing machine. Its mechanical strength in its use, however, is not very high. High-density polyethylene (HDPE) on the other hand shows lower shear thinning, thus harder and costlier to process, but has much improved mechanical properties as compared to LDPE.

The presence of long-chain branching (LCB) in polyolefins, among them LCB in polyethylene, is often desirable as it enhances melt processability by shear-thinning. This phenomenon affords a given melt processing speed at reduced cost by requiring less power. LCB may also impart strain-hardening that can improve film production properties by improved bubble stability.

To improve processability by improved shear-thinning, LCB is often introduced into HDPE by compounding HDPE lacking LCB with LDPE including LCB made in a separate process. This blending, however, brings in a broad range of LCB structures created in the LDPE process and leads to a significant reduction of the mechanical strength as compared to the parent HDPE. A better control of LCB is desirable to improve the balance of processability and mechanical properties of PE.

LCB can also be introduced into an HDPE solution polymerization process by adding dienes with two reactive double bonds, like vinyl norbornene (VNB), alpha-omega dienes, like 1,7-octadiene, or 1,9-decadiene, and the like. Controlling LCB and avoiding gel formation, however, is often difficult in these processes.

Another method of introducing LCB in HDPE is the use of free-radical initiators in the HDPE extruder. However, the cost of the initiators significantly increases the cost of production. Also, these processes are hard to control due to the difficulty of efficiently and quickly distributing the free-radical initiator in the high-viscosity polymer melt. The molecular architecture created by this process is dependent on the local concentration of free radicals. It can also lead to undesirable chain degradation and gel formation.

Yet another method of introducing LCB in HDPE is the use of vinyl-terminated macromers made in a separate upstream reactor. When the LCB-forming vinyl-terminated macromer is created in a separate reactor, only a small fraction of the vinyl-terminated macromer is incorporated into the LCB PE, the rest dilutes the product polymer. This dilution often undesirably reduces the performance of the product polymer.

In addition to the effect of LCB or lack of LCB, a narrow molecular weight distribution (MWD) tends to make high-density polyethylene (HDPE) grades having higher mechanical strength than the corresponding more conventional low-density polyethylene (LDPE) grades harder to process due to their lower shear-thinning. One method to address this this is to produce HDPE having a broader molecular weight distribution. However, introducing a broader molecular weight distribution can undesirably lead to less control over the rheological properties of the HDPE, such as the degree of shear-thinning.

### SUMMARY

One or more embodiments of the disclosed invention include contacting an ethylene feed containing ethylene monomers with a catalyst feed containing a hafnium-based or zirconium-based single-site catalyst in a solution in a reactor so as to polymerize the ethylene monomers into long-chain-branched high density polyethylene having on average a long-chain-branch/polymer chain less than 10 and greater than 0.25.

One or more embodiments of the disclosed invention include ethylene; a hafnium-based or zirconium-based single-site catalyst; and a long-chain-branched high density polyethylene polymerization product, wherein the long-chain branched high density polyethylene has on average a long-chain branch/polymer chain less than 10 and greater than 0.25; and wherein at least one of the ethylene, the catalyst, and the product is in solution.

One more embodiments of the disclosed invention include maintaining a polymerization mixture at a polymerization reactor temperature at or above the crystallization temperature of the dissolved product polymer, while maintaining the polymerization mixture at steady state, where the polymerization mixture is substantially uniform in temperature, pressure, and concentration, where the polymerization mixture includes solvent, monomer including ethylene and optionally monomer copolymerizable with ethylene, a single-site catalyst system, and polymer resulting from the polymerization of the monomer, where the monomer and the polymer are dissolved in the solvent, and where the polymer is an ethylene-based polyolefin having a molecular weight distribution (Mw/Mn) of less than 2.50 and greater than 2.0 and having long-chain branching wherein on average a long-chain branch/polymer chain less than 10 and greater than 0.25.

### BRIEF DESCRIPTION OF THE DRAWINGS

Embodiments of the solution polymerization process for making high density polyethylene with long-chain branching are described with reference to the following figures.

FIG. 1 is a graph of a plot of extensional viscosity vs. time of long-chain branched high density polyethylene for an exemplary long-chain branched polyethylene and a linear reference; and

FIG. 2 is a graph of a “Van Gurp-Palmen” plot, that is phase angle vs shear modulus, for another exemplary long-chain branched polyethylene and another linear reference.

### DETAILED DESCRIPTION

This disclosure provides processes, compositions, and systems for producing controlled amounts of long-chain branching (LCB) in high density polyethylene (HDPE), while also producing controlled narrow molecular weight distributions for the HDPE. For example, this disclosure provides combinations of process conditions and single-site catalysts that introduce controlled amounts of LCB in polyethylene made in solution in a single reactor affording polyethylene with improved shear-thinning and better green strength. The disclosed processes, compositions, and systems solve the problem of HDPE with superior mechanical properties tending to be difficult to process due to low shear-thinning by introducing controlled levels of LCB to increase shear-thinning and thus improve melt processability, while also introducing controlled narrow molecular weight distributions. The disclosed processes, compositions, and systems eliminate the need for compounding with LDPE and thus save cost.

The present inventors have surprisingly found that these advantageous properties can be manufactured in a single solution polymerization reactor by a novel combination of reactor conditions and catalyst selection. The process could be deployed in a commercial continuous reactor operating at lower pressure in the liquid-liquid biphasic solution regime or in a commercial continuous reactor operating at higher pressure in the single liquid phase solution regime. The process of the current disclosure polymerizes ethylene at suitable reactor conditions using advantageously-selected single-site catalysts in mixed/stirred continuous reactors filled with liquid single-phase, or liquid-liquid biphasic reaction medium to yield high-density polyethylene (HDPE) with improved melt-flow properties due to increased shear-thinning.

Without being bound by theory, the present inventors believe that the improved shear-thinning of the HDPE made by the processes of this disclosure is due to the in-situ generated controlled levels of long-chain branching (LCB). The high-density polyethylene products with improved melt-flow properties made in the processes of the current disclosure will be referred to herein as long-chain-branched high density polyethylene, or LCB HDPE. The presence of LCB is reported to result in a larger drop in melt viscosity under increasing shear than what is observed with linear polymers having the same composition and molecular weight (MW), the latter of which can be also expressed as melt index (MI), which is easier and faster to obtain and widely used in industry. This LCB effect allows the processing of polymers with higher low-shear melt viscosity at reduced cost. The LCB effect enhances melt processability by shear-thinning. This phenomenon affords a given melt processing speed at reduced cost by requiring less power. The shear properties are particularly advantageous when the polymer needs to retain its shape in extrusion and are often described in the art of polymer processing as increased green strength. The other interesting property provided by the presence of LCB is strain-hardening. It manifests itself in increasing resistance to stretching at the high end of the stress-strain curve. Strain-hardening can improve film properties.

The process of this disclosure generates controlled levels of LCB without gel formation, thus avoids yield losses associated with diene or free-radical initiator use. Since it creates LCB in the process, and indeed can make LCB-containing PE even in a single reactor, without the use of additional reagents or comonomers, or the need for compounding, it reduces manufacturing cost. It also creates LCB in a targeted, controlled fashion unlike blending with LDPE, thus can afford better processability/use properties balance.

While the processes of this disclosure can yield polyethylene products that contain LCB (LCB PE) in a single reactor, they may also be practiced in processes utilizing two or more reactors connected in parallel or series. Such combinations may advantageously be used for tailoring the molecular weight and/or the composition distributions of the product. In one embodiment of the processes of the current disclosure LCB PE could be made in one of the reactors while an ethylene-rich copolymer, like linear low-density polyethylene (LLDPE) could be made in a second reactor. The two reactors could be connected in series or parallel to make LLDPE that contains controlled amounts of LCB brought in by the LCB PE component. This is just but one potential example for the use of the LCB generating solution polymerization process of the current disclosure. Many other combinations yielding different products are also envisioned. The common feature of these processes is that they have at least one reactor making an LCB PE component for making useful polymer blends in a process utilizing two or more reactors in parallel or series.

In general, while pressure and temperature may be selected to ensure fouling-free operations in the processes of this disclosure, various temperatures and pressures as described in this disclosure are suitable for LCB formation. Similarly, solution processes of the current disclosure may operate in single liquid phase or in a liquid-liquid biphasic mode. Controlled LCB formation may be achieved in either single phase or biphasic operation mode when the solution polymerization reactor conditions and catalyst properties are set according to this disclosure.

Embodiments of the invention are based, at least in part, on the discovery of a continuous process for solution polymerizing ethylene, optionally together with one or more comonomers, at a pressure and temperature below or above the lower critical separation temperature (LCST) to thereby produce an ethylene-based polyolefin having a controlled molecular weight distribution, Mw/Mn, of less than 2.5 and controlled long-chain branching. In one or more embodiments, this continuous solution polymerization process employs a single-site catalyst that is soluble within the polymerization mixture, and the polymerization mixture is uniform and maintained at steady state above the solution crystallization temperature of the product polymer. Aspects of the present invention advantageously provide the polymer with long-chain branching and with narrow molecular weight distribution, which has unexpectedly been achieved by the appropriate selection of process parameters and catalyst. Embodiments of the invention are therefore directed toward these polymerization processes, as well as the single liquid phase and liquid-liquid biphasic polymerization mixtures that are utilized by and produced by these processes.

### Process—General

According to embodiments of the present invention, monomer, optionally together with one or more comonomers, single-site catalyst, and solvent are continuously combined within a reactor to form a polymerization mixture, which may be referred to as a reaction medium, that upon polymerization of the monomer and optionally the one or more comonomers also includes ethylene-based polyolefin. The polymerization mixture is maintained at a temperature and pressure either below (liquid single phase conditions) or above the LCST (liquid-liquid biphasic conditions) as a uniform polymerization system operated at steady state while a portion of the polymerization mixture is continuously removed from the reactor, where LCST is the lower critical solution temperature. The polymerization mixture is also maintained at a temperature above the crystallization temperature of the product polymer to maintain the product polymer in a dissolved state. Without being bound by theory, the present inventors believe that maintaining the variation of values of temperature and pressure in a narrow range assists to produce HDPE with a narrow molecular weight distribution. The monomer feed rate and/or monomer concentration in the reactor are adjusted according to the catalyst, temperature, and pressure to deliver the desired product properties. Without being bound by theory, the present inventors believe that adjusting the monomer feed rate and/or monomer concentration in the reactor are adjusted according to the catalyst, temperature, and pressure assists to produce HDPE with a weight-average molecular weight above a target value and/or a melt index below a target value. The reactor is maintained with sufficient circulation to ensure good mixing characterized by desirably low temperature and concentration differences in different parts of the polymerization reactor. Without being bound by theory, the present inventors believe that good mixing assists to produce HDPE with controlled long-chain branching (LCB).

### Monomer

In one or more embodiments, monomer includes ethylene and optionally additional monomer(s), also termed herein comonomer(s), polymerizable with ethylene, the latter of which may be referred to as comonomer. Examples of monomers copolymerizable with ethylene include propylene, alpha-olefins (which include C₄ or higher 1-alkenes), vinyl aromatics, vinyl cyclic hydrocarbons, and dienes such as cyclic dienes and alpha-omega dienes.

In one or more embodiments, the alpha-olefin includes a C₄ to C₁₂ alpha-olefin. Examples of alpha-olefins include 1-butene, 1-pentene, 1-hexene, 1-heptene, 1-octene, 1-decene, 1-dodecene, 4-methyl-1-pentene, and 3-methyl-1-pentene.

Examples of vinyl cyclic hydrocarbons include vinyl cycloalkanes, such as vinyl cyclohexane and vinyl cyclopentane. Exemplary vinyl aromatics include styrene and substituted styrenes such as alphamethylstyrene.

Exemplary cyclic dienes include vinylnorbornene, norbornadiene, ethylidene norbornene, divinylbenzene, cyclopentadiene, dicyclopentadiene or higher ring-containing diolefins with or without substituents at various ring positions.

Examples of alpha-omega dienes include butadiene, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 1,14-pentadecadiene, 1,15-hexadecadiene, 1,16-heptadecadiene, 1,17-octadecadiene, 1,18-nonadecadiene, 1,19-icosadiene, 1,20-heneicosadiene, 1,21-docosadiene, 1,22-tricosadiene, 1,23-tetracosadiene, 1,24-pentacosadiene, 1,25-hexacosadiene, 1,26-heptacosadiene, 1,27-octacosadiene, 1,28-nonacosadiene, 1,29-triacontadiene, and low molecular weight polybutadienes (weight average molecular weight, Mw, less than 1000 g/mol).

In one or more embodiments, the ethylene concentration within the reactor (which exists in the polymerization mixture) relative to the total monomer content (i.e., ethylene plus all comonomer) is greater than 45 wt %, in other embodiments greater than 50 wt %, in other embodiments greater than 55 wt %, in other embodiments greater than 60 wt %, in other embodiments greater than 65 wt %, in other embodiments greater than 70 wt %, in other embodiments greater than 75 wt %, in other embodiments greater than 80 wt %, in other embodiments greater than 85 wt %, in other embodiments greater than 90 wt %, and in other embodiments greater than 95 wt % of the total weight of monomer. In one or more embodiments, considering that the molecular weight of ethylene is lower than the molecular weight of comonomer, the concentration of ethylene will be greater than 50 mol %.

In particular embodiments, one or more dienes are present in the polymerization mixture. For example, the polymerization mixture may include dienes at up to 10 wt %, or 0.00001 to 1.0 wt %, or 0.002 to 0.5 wt %, or 0.003 to 0.2 wt %, based upon the total weight of the monomer. In some embodiments 500 wt ppm (parts per million by weight) or less of diene is added to the polymerization mixture, or 400 wt ppm or less, preferably, or 300 wt ppm or less. In other embodiments, at least 50 wt ppm of diene is added to the polymerization mixture, or wt 100 ppm or more, or 150 wt ppm or more. In particular embodiments, the polymerization mixture is devoid of diene monomer.

In certain embodiments, the monomer feed is essentially pure ethylene and the polymer product composition corresponds to what is known as high-density polyethylene (HDPE) in the art of polyolefin production. In certain embodiments, the ethylene concentration in the reactor feed in the processes of the current disclosure ranges between 5 and 40, or between 6 and 40, or between 7 and 40, or between 8 and 40, or between 9 and 40, or between 5 and 35, or between 6 and 35, or between 7 and 35, or between 8 and 35, or between 9 and 35 wt % based on the total feed stream of the reactor. The ethylene concentration in the reactor solution may range between 5 and 40, or between 6 and 40, or between 7 and 40, or between 8 and 40, or between 9 and 40, or between 5 and 35, or between 6 and 35, or between 7 and 35, or between 8 and 35, or between 9 and 35 wt % based on the total feed stream of the reactor.

The single-pass ethylene conversion in the reactor of the processes of the current disclosure may be above 25%, or above 30%, or above 35%, or above 40%, or above 45%, or above 50%, or above 55%, or above 60%, or above 65%, or above 70%, or above 75%, or above 80%, or above 85%, or above 90%, or even above 95%. Generally higher conversion of a given ethylene feed concentration favors LCB formation, but reduces Mw/increases MI. However, in order to produce LCB HDPE with enhanced shear-thinning, the product has to have a minimum MW (or MI must be below a corresponding maximum). Therefore, the conversion in the reactor is set with a given catalyst to maintain an MI or Mw that falls within the advantageous ranges specified above while also satisfying the needs of the target product applications.

### Solvent

In one or more embodiments, useful solvents include non-coordinating, inert liquids that dissolve the single-site catalyst, the monomer, and the resulting polymer. In other words, useful solvents provide a solution polymerization system wherein the single-site catalyst, monomer, and polymer are molecularly dispersed.

Examples of useful solvents include straight- and branched-chain paraffinic hydrocarbons, such as butane, isobutane, pentane, isopentane, hexanes, isohexane, heptane, isoheptane, octane, isooctane, decane, dodecane, and mixtures thereof; cyclic and alicyclic hydrocarbons, such as cyclopentane, cyclohexane, cycloheptane, methylcyclopentane, methylcyclohexane, methylcycloheptane, and mixtures thereof; perhalogenated hydrocarbons, such as perfluorided C₄₋₁₀ alkanes, chlorobenzene, and aromatic and alkylsubstituted aromatic compounds, such as benzene, toluene, mesitylene, and xylene. In another embodiment, the solvent is non-aromatic. In particular embodiments, aromatics are present in the solvent at less than 1 wt %, or less than 0.5 wt %, or less than 0.1 wt % based upon the weight of the solvents. In other embodiments, the solvent is essentially free of benzene.

In certain embodiments, the solvent is a hexane. In certain embodiments, the solvent is selected from n-hexane, i-hexane, and combinations thereof. In certain embodiments, the solvent is n-hexane. In certain embodiments, the solvent is i-hexane.

### Single-Site Catalyst

For purposes of this specification, a single-site catalyst (SSC) refers to an active catalyst system that includes a transition metal center (e.g., a metal of group 3 to 10 of the Periodic Table) and at least one mono-anionic ligand that can be abstracted thereby allowing for the insertion of the ethylene or comonomer. The active catalyst system (i.e., active single-site catalyst system) is formed by combining a transition metal precursor compound (such as a metallocene compound) with an activator compound. Single-site catalysts are well known in the art as described in Metallocene-Based Polyolefins, J. Scheirs and W. Kaminsky, Eds., Wiley, New York, 2000; and Stereoselective Polymerization with Single-Site Catalysts, L. S. Baugh and J. A. M. Canich, Eds., CRC, New York, 2008. Suitable single-site catalysts include those referred to in the art of single-site catalysts as metallocenes, constraint-geometry catalyst, and the like. The single-site catalyst may be employed in a reactor, and may be effective to produce the polymers of the present disclosure in a single reactor.

In one or more embodiments, the active catalyst may be present as an ion pair of a cation and an anion, where the cation derives from the transition metal precursor compound (e.g., metallocene compound) and the anion derives from the activator compound (e.g., the transition metal is in its cationic state and is stabilized by the activator compound or an anionic species thereof). In one or more embodiments, the mono-anionic ligands are displaceable by a suitable activator to permit insertion of a polymerizable monomer at the vacant coordination site of the transition metal component.

In one or more embodiments, a single, single-site catalyst is included with the polymerization. In other words, within these embodiments, a single transition metal precursor species is combined with a single activator species.

In certain embodiments, the catalysts of this disclosure have a suitable affinity for incorporating the in-situ formed macromer thus capable of creating rheologically effective LCB. This property can be determined by performing ethylene-octene copolymerizations at 120-160° C. and ethylene conversions of higher than 70%, or higher than 75%, higher than 80%, or higher than 85%, or higher than 90%. At these conditions, catalysts suitable for making the inventive LCB HDPE products yield ethylene-octene HDPEs that contain more than 0.2, or more than 0.3, or more than 0.4, or more than 0.5 mol % octene as determined by ¹³C NMR or by melting peak depression measured in Differential Scanning Calorimetry (DSC) even with feeds containing less than or equal of about 2.0, or less than or equal of about 1.5, or less than or equal of about 1.4, or less than or equal of about 1.3, or less than or equal of about 1.2, or less than or equal of about 1.1, or less than or equal of about 1.0, or less than or equal of about 0.9, or less than or equal of about 0.8, or less than or equal of about 0.7, or less than or equal of about 0.6 mol % octene in the combined monomer feed.

Suitable catalysts typically form by reacting a catalyst precursor with an activator upstream of the reactor or in the reactor. In the art of single site polymerization the terms of catalyst and catalyst precursor are used interchangeably. However, strictly speaking, active catalysts are typically formed by reacting an organometallic precursor with an activator compound, thus the two are not the same. The active catalysts are often present as ion pairs of a cation and an anion. The cation of the active catalyst is formed from the catalyst precursor, while the anion of the active catalyst is formed from the activator. Examples of suitable activators are numerous in the literature. The most frequently used activators belong to the chemical families of metal alkyls, methyl aluminoxanes (MAO), and non-coordinating anion activators, such borates, etc.

### Catalyst Precursor Transition Metal Compounds

As suggested above, the precursor compound can include a metallocene compound, or it may include a non-metallocene transition metal compound.

In one or more embodiments, the transition metal precursor compound is a metallocene compound. Metallocene compounds include compounds with a central transition metal and at least two ligands selected from cyclopentadienyl ligands and ligands that are isolobal to cyclopentadienyl ligands. Exemplary transition metals include Group 4 (also known as Group IV) of the Periodic table, such as titanium, hafnium or zirconium. Exemplary cyclopentadienyl ligands, or ligands isolobal thereto, include, but are not limited to, cyclopentadienyl ligands, cyclopentaphenanthrenyl ligands, indenyl ligands, benzindenyl ligands, fluorenyl ligands, octahydrofluorenyl ligands, cyclooctatetraenyl ligands, cyclopentacyclododecene ligands, azenyl ligands, azulene ligands, pentalene ligands, phosphoyl ligands, phosphinimine ligands (WO 1999/040125), pyrrolyl ligands, pyrazolyl ligands, carbazolyl ligands, borabenzene ligands and the like, including hydrogenated versions thereof, for example tetrahydroindenyl ligands. These ligands may include one or more heteroatoms, for example, nitrogen, silicon, boron, germanium, sulfur and phosphorus, in combination with carbon atoms to form an open, acyclic, or a fused, ring or ring system, for example, a heterocyclopentadienyl ancillary ligand. Other ligands include but are not limited to porphyrins, phthalocyanines, corrins and other polyazamacrocycles. The metallocene compounds may be bridged or unbridged, or they may be substituted or unsubstituted. For purposes of this specification, the term “substituted” means that a hydrogen group has been replaced with a hydrocarbyl group, a heteroatom, or a heteroatom containing group. For example, methyl cyclopentadiene is a ligand group substituted with a methyl group.

In one or more embodiments, useful metallocene compounds may be defined by the formula: L^{A}L^{B}L^{C}ᵢMDE where, L^{A} is a substituted cyclopentadienyl or hetero-cyclopentadienyl ligand 7L-bonded to M; L^{B} is a member of the class of ligands defined for L^{A}, or is J, a hetero-atom ligand Σ-bonded to M; the L^{A} and L^{B} ligands may be covalently bridged together through a Group 14 element linking group; L^{C}ᵢ is an optional neutral, non-oxidizing ligand (ᵢ equals 0 to 3); M is a Group 4 or 5 transition metal; and, D and E are independently mono-anionic labile ligands, each having a Σ-bond to M, optionally bridged to each other or L^{A} or L^{B}.

Other examples include metallocenes that are biscyclopentadienyl derivatives of a Group 4 transition metal, such as zirconium or hafnium. See e.g. WO 1999/041294. These may advantageously be derivatives containing a fluorenyl ligand and a cyclopentadienyl ligand connected by a single carbon and silicon atom. See e.g. WO 1999/045040 and WO 1999/045041. In particular embodiments, the cyclopentadienyl ligand (Cp) is unsubstituted and/or the bridge contains alkyl substituents, in certain embodiments alkylsilyl substituents, to assist in the alkane solubility of the metallocene. See WO 2000/024792 and WO 2000/024793. Other possible metallocenes include those in WO 2001/058912.

Still other metallocene compounds are disclosed in EP 418044, including monocyclopentadienyl compounds similar that that EP 416815. Similar compounds are also described in EP 420436. Yet others are disclosed in WO 1997/003992, which discloses a catalyst in which a single Cp species and a phenol are linked by a C or Si linkage, such as Me2C(Cp)(3-tBu-5-Me-2-phenoxy)TiCl2. And, WO 2001/005849 discloses Cp-phosphinimine catalysts, such as (Cp)((tBu)3P═N—)TiCl2.

Other suitable metallocenes may be bisfluorenyl derivatives or unbridged indenyl derivatives, which may be substituted at one or more positions on the fused ring with moieties that have the effect of increasing the molecular weight and so indirectly permit polymerization at higher temperatures such as described in EP 693506 and EP 780395.

In other embodiments, the transition metal precursor is a non-metallocene transition metal compound. Representative non-metallocene transition metal compounds useful for forming a single-site catalyst include tetrabenzyl zirconium, tetra bis(trimethylsiylmethyl) zirconium, oxotris(trimethlsilylmethyl) vanadium, tetrabenzyl hafnium, tetrabenzyl titanium, bis(hexamethyl disilazido)dimethyl titanium, tris(trimethyl silyl methyl) niobium dichloride, and tris(trimethylsilylmethyl) tantalum dichloride.

In certain embodiments, the catalyst precursor is a metallocene precursor selected from dimethyl (μ-di(p-triethylsilylphenyl)silyl)(3,8-di-tert-butylfluorenylindenyl)hafnium, dimethyl[(dimethylsilylene)bis[(1,2,3,3a,7a-h)-4,5,6,7-tetrahydro-1H-ind en-1-ylidene]]-zirconium, and combinations thereof. Hafnium and zirconium are examples of Group 4 transition metals. dimethyl (μ-di(p-triethylsilylphenyl)silyl)(3,8-di-tert-butylfluorenylindenyl)hafnium and dimethyl[(dimethylsilylene)bis[(1,2,3,3a,7a-h)-4,5,6,7-tetrahydro-1H-ind en-1-ylidene]]-zirconium are examples of metallocene compounds defined by the formula: L^{A}L^{B}L^{C}ᵢMDE where, L^{A} is a substituted cyclopentadienyl or hetero-cyclopentadienyl ligand 7L-bonded to M; L^{B} is a member of the class of ligands defined for L^{A}, or is J, a hetero-atom ligand Σ-bonded to M; the L^{A} and L^{B} ligands may be covalently bridged together through a Group 14 element linking group; L^{C}ᵢ is an optional neutral, non-oxidizing ligand (i equals 0 to 3); M is a Group 4 or 5 transition metal; and, D and E are independently mono-anionic labile ligands, each having a Σ-bond to M, optionally bridged to each other or L^{A} or L^{B}. Si is an example of a Group 14 element linking group.

In certain embodiments, the catalyst precursor is dimethyl (μ-di(p-triethylsilylphenyl)silyl)(3,8-di-tert-butylfluorenylindenyl)hafnium, designated herein μ-di(p-triethylsilylphenyl)silyl)(3,8-di-tert-butylfluorenylindenyl is a ligand. The structure of dimethyl (μ-di(p-triethylsilylphenyl)silyl)(3,8-di-tert-butylfluorenylindenyl)hafnium is shown below:

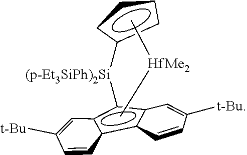

In certain embodiments, the catalyst precursor is dimethyl[(dimethylsilylene)bis[(1,2,3,3a,7a-h)-4,5,6,7-tetrahydro-1H-ind en-1-ylidene]]-zirconium. [(dimethylsilylene)bis[(1,2,3,3a,7a-h)-4,5,6,7-tetrahydro-1H-ind en-1-ylidene], is another ligand. The structure of dimethyl[(dimethylsilylene)bis[(1,2,3,3a,7a-h)-4,5,6,7-tetrahydro-1H-ind en-1-ylidene]]-zirconium is shown below:

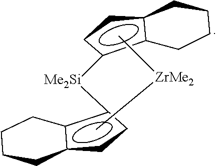

### Activator Compounds

In one or more embodiments, the activator compound, which may be referred to simply as an activator, may be an alumoxane, such as methylalumoxane. The alumoxanes may have an average degree of oligomerization of from 4 to 30, as determined by vapor pressure osmometry. The alumoxane may be modified to provide solubility in linear alkanes or be used in a slurry (e.g. may include a toluene solution). These solutions may include unreacted trialkyl aluminum, and the alumoxane concentration is generally indicated as mol A1 per liter, which figure includes any trialkyl aluminum that has not reacted to form an oligomer. The alumoxane, when used as an activator compound, is generally used in molar excess, at a mol ratio of 50 or more, or 100 or more, or 1000 or less, or 500 or less, relative to the transition metal precursor compound.

### Non-Coordinating Anion

In one or more embodiments, the activator compound is a compound (i.e. activator precursor) that gives rise to a non-coordinating anion, which is a ligand that weakly coordinates with the metal cation center of the transition metal compound. For purposes of this specification, the term non-coordinating anion includes weakly coordinating anions. As the skilled person will appreciate, the coordination of the non-coordinating anion should be sufficiently weak to permit the insertion of the unsaturated monomer component.

In one or more embodiments, the activator precursor for the non-coordinating anion may be used with a metallocene supplied in a reduced valency state. In one or more embodiments, the activator precursor may undergo a redox reaction. In one or more embodiments, the precursor may be an ion pair of which the precursor cation is neutralized and/or eliminated in some manner. For example, the precursor cation may be an ammonium salt as in EP 277003 and EP 277004. In other examples, the precursor cation may be a triphenylcarbonium derivative.

In one or more embodiments, the activator precursor may include borates or metal alkyls. In one or more embodiments, the non-coordinating anion can be a halogenated, tetra-aryl-substituted Group 10-14 non-carbon element-based anion, especially those that are have fluorine groups substituted for hydrogen atoms on the aryl groups, or on alkyl substituents on those aryl groups. For example, effective Group 10-14 element activator complexes may be derived from an ionic salt including a 4-coordinate Group 10-14 element anionic complex. In one or more embodiments, the anion can be represented as: [(M′)Q₁Q₂ . . . Qᵢ]⁻, where M is one or more Group 10-14 metalloid or metal, (e.g. boron or aluminum), and each Q is a ligand effective for providing electronic or steric effects rendering[(M′)Q₁Q₂ . . . Qₙ]⁻ suitable as a non-coordinating anion as that is understood in the art, or a sufficient number of Q are such that [(M′)Q₁Q₂ . . . Qₙ]⁻ as a whole is an effective non-coordinating or weakly coordinating anion specifically include fluorinated aryl groups, (e.g., perfluorinated aryl groups), and include substituted Q groups having substituents additional to the fluorine substitution, such as fluorinated hydrocarbyl groups. Exemplary fluorinated aryl groups include phenyl, biphenyl, naphthyl and derivatives thereof.

In one or more embodiments, the non-coordinating anion may be used in approximately equimolar amounts relative to the transition metal component, such as at least 0.25, or at least 0.5, or at least 0.8, or at least 1.0, or at least 1.05. In these or other embodiments, non-coordinating anion may be used in approximately equimolar amounts relative to the transition metal component and such as no more than 4, preferably 2 and especially 1.5.

In certain embodiments, the catalyst precursor is activated by non-coordinating borate activators. In certain embodiments, the activator is selected from dimethylanilinium-tetrakis(perfluorophenyl)borate, dimethylanilinium-tetrakis(heptafluoronaphthyl)borate, and combinations thereof. Dimethylanilinium-tetrakis(perfluorophenyl)borate and dimethylanilinium-tetrakis(heptafluoronaphthyl)borate are examples of non-coordinating borate activators. In certain embodiments, the activator is dimethylanilinium-tetrakis(perfluorophenyl)borate. The composition of dimethylanilinium-tetrakis(perfluorophenyl)borate is shown below:

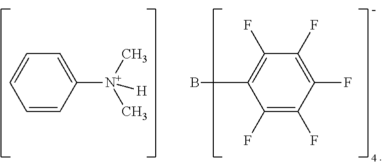

In certain embodiments, the activator is dimethylanilinium-tetrakis(heptafluoronaphthyl)borate. The composition of dimethylanilinium-tetrakis(heptafluoronaphthyl)borate is shown below:

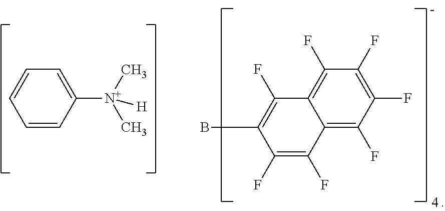

### Scavengers

In one or more embodiments, the polymerization mixture may additionally include a scavenger compound, which may include an organometallic compound. These compounds are effective for removing polar impurities from the reaction environment and/or for increasing catalyst activity. As the skilled person appreciates, impurities can be inadvertently introduced to the polymerization mixture (e.g., with any of the polymerization reaction components, solvent, monomer and catalyst), which can adversely affect catalyst activity and stability. By way of example, these impurities can include, without limitation, water, oxygen, heteroatom-containing polar organic compounds, metal impurities, etc.

Exemplary scavengers include organometallic compounds such as the Group 13 organometallic compounds. Specific examples include triethyl aluminum, triethyl borane, tri-isobutyl aluminum, tri-n-octyl aluminum, methylalumoxane, and isobutyl alumoxane. Alumoxane also may be used in scavenging amounts with other means of activation, e.g., methylalumoxane and tri-isobutyl-aluminoxane with boron-based activators. In one or more embodiments, the amount of scavenger used with catalyst compounds of the inventions is minimized during polymerization reactions to that amount effective to enhance activity (and with that amount necessary for activation of the catalyst compounds if used in a dual role) since excess amounts may act as catalyst poisons. Useful scavengers are disclosed in U.S. Pat. Nos. 5,153,157 and 5,241,025, as well as PCT International Publications WO 1991/009882, WO 1994/003506, WO 1993/014132, and WO 1995/007941.

### Formation of Active Catalyst

In one or more embodiments, the single-site catalyst may be formed by combining the precursor compound with the activator compound, optionally together with a scavenger, prior to introducing the single-site catalyst to the monomer to be polymerized. In this regard, reference may be made to a pre-formed single-site catalyst system. In other embodiments, the single-site catalyst may be formed in situ within the reactor in which the polymerization of monomer takes place. For example, the precursor compound and the activator compound may be introduced to the reactor separately and individually (e.g., via separate feed streams).

### Ethylene-Based Polyolefins

As indicated above, polymerization of monomer with the single-site catalyst leads to the formation of ethylene-based polyolefin, which is included in the polymerization mixture. For purposes of this specification, ethylene-based polyolefins include polyethylene homopolymer, polyethylene copolymers, and mixtures thereof. Polyethylene copolymers are copolymers including ethylene-derived units and comonomer-derived units. In other words, the polyethylene copolymers are prepared from the polymerization of ethylene and one or more comonomer(s), which comonomer(s) are described herein above.

According to embodiments of the present invention, the ethylene-based polyolefins may be characterized by the amount of comonomer-derived units, other than ethylene-derived units, within the composition. As the skilled person will appreciate, the amount of comonomer-derived units (i.e., non-ethylene units) can be determined by nuclear magnetic resonance analysis, which may be referred to as NMR analysis.

In one or more embodiments, the ethylene-based polyolefin may include greater than 0.5, in other embodiments greater than 1, and in other embodiments greater than 3 mol % comonomer-derived units other than ethylene-derived units, with the balance including ethylene-derived units. In these or other embodiments, the ethylene-based polyolefins may include less than 20, in other embodiments less than 15, in other embodiments less than 10, and in other embodiments less than 7 mol % comonomer-derived units other than ethylene-derived units, with the balance including ethylene-derived units. In one or more embodiments, the polyethylene composition of the present invention may include from about 0.5 to 20 mol %, in other embodiments from 1 to 15 mol %, and in other embodiments from 3 to 10 mol % comonomer-derived units other than ethylene-derived units, with the balance including ethylene-derived units.

The ethylene-based polyolefins of the present invention may be characterized by their number average molecular weight (Mn), which may be measured by using the technique set forth below. According to embodiments of the present invention, the ethylene-based polyolefins may have a number average molecular weight, Mn, of greater than 10,000, in other embodiments greater than 12,000, in other embodiments greater than 15,000, and in other embodiments greater than 20,000 g/mol. In these or other embodiments, the ethylene-based polyolefins may have a Mn of less than 200,000, in other embodiments less than 100,000, in other embodiments less than 80,000, and in other embodiments less than 60,000 g/mol. In one or more embodiments, the ethylene-based polyolefins have a Mn of from about 10,000 to about 200,000, in other embodiments from about 12,000 to about 100,000, in other embodiments from about 15,000 to about 80,000, and in other embodiments from about 20,000 to about 60,000 g/mol.

The ethylene-based polyolefins of the present invention may be characterized by their weight average molecular weight (Mw), which may be measured by using the technique set forth below. According to embodiments of the present invention, the ethylene-based polyolefins may have a Mw of greater than 40,000, in other embodiments greater than 80,000, in other embodiments greater than 90,000, and in other embodiments greater than 100,000 g/mol. In these or other embodiments, the ethylene-based polyolefins may have a Mw of less than 500,000, in other embodiments less than 400,000, in other embodiments less than 300,000, in other embodiments less than 250,000, in other embodiments less than 200,000, and in other embodiments less than 180,000 g/mol. In one or more embodiments, the ethylene-based polyolefins have a Mw of from about 40,000 to about 500,000, in other embodiments from about 80,000 to about 500,000, in other embodiments from about 80,000 to about 400,000, in other embodiments from about 90,000 to about 200,000, and in other embodiments from about 100,000 to about 180,000 g/mol.

The ethylene-based polyolefins of the present invention may be characterized by their molecular weight distribution (expressed as the Mw/Mn ratio), which may also be referred to as polydispersity, where Mw and Mn may be measured by using the technique set forth below. According to embodiments of the present invention, the ethylene-based polyolefins have a Mw/Mn of less than 2.50, in other embodiments less than 2.40, in other embodiments less than 2.30, in other embodiments less than 2.25, in other embodiments less than 2.20, in other embodiments less than 2.10, and in other embodiments essentially equal to 2.00. In one or more embodiments, the ethylene-based polyolefins have an Mw/Mn of from about 2.00 to about 2.28, in other embodiments from about 2.05 to about 2.25, and in other embodiments from about 2.10 to about 2.23.

### Long-Chain Branching

The melt-flow improvement (higher shear thinning) achieved by in-situ generating LCB in the processes of this disclosure depends on the length of the branches, also called arms in the art of polymers. The longer the branch (arm), the more effective it is in enhancing shear-thinning, i.e, the same shear-thinning can be achieved with lower branch concentrations, or higher degree of shear-thinning can be achieved with longer branches at the same branch concentrations. Since the branches in the processes of the current disclosure are formed by in-situ incorporating some of the macromer molecules made in the reactor into the growing chains, the molecular weight of the products made by the processes of the current disclosure need to be higher than a certain minimum weight-average molecular weight (Mw) for producing the herein-disclosed LCB HDPE with improved melt flow behavior as compared to the prior-art linear HDPE.

In certain embodiments, the LCB HDPE products made in the processes of the present disclosure typically have weight-average molecular weights (Mw) of higher than 42, or higher than 44, or higher than 47, or higher than 51, or higher than 56, or higher than 67, or higher than 102, or higher than 122 kg/mol. This LCB HDPE product criterion can also be expressed in the corresponding melt index (MI) values, which are easier to measure. Thus, the LCB HDPE products made in the processes of the present disclosure typically have melt index (MI) values of less than 30, or less than 25, or less than 20, or less than 15, or less than 10, or less than 5, or less than 1, or less than 0.5 g/10 min, respectively.

In certain embodiments, the LCB HDPE products made by the processes of the present disclosure are gel-free and have controlled amounts of LCB with a characteristic branching architecture. Thus, the LCB HDPE products made by the processes of the present disclosure on average have less than 5, or less than 4, or less than 3, or less than 2, or less than 1 long-chain branch/polymer chain.

As one of ordinary skill in the art will appreciate, the average number of branches/chain can be determined by ¹³C nuclear magnetic resonance (NMR) analysis, for example by using the method published by L. Hou et al. (2012) Polymer, v.53, pg. 4329 and P. B. Smith et al. (1991) Journal of Applied Polymer Science, v.42, pg. 399, or can be estimated by using the Branch-on-Branch (BoB) model as described in D. J. Read and T. C. B. McLeish (2001) Macromolecules, v.34 pg. 1928 and in D. J. Read et al. (2011) Science, v.333, pg. 1871.

### GPC 3D Methodology

Mw, Mn and Mw/Mn may be determined by using a High Temperature Gel Permeation Chromatography (Agilent PL-220), equipped with three in-line detectors, a differential refractive index detector (DRI), a light scattering (LS) detector, and a viscometer. Experimental details, including detector calibration, are described in: T. Sun, P. Brant, R. R. Chance, and W. W. Graessley (2001) Macromolecules, v.34(19), pp. 6812-6820, and references therein. Three Agilent PLgel 10 μm Mixed-B LS columns are used. The nominal flow rate is 0.5 mL/min, and the nominal injection volume is 300 μL. The various transfer lines, columns, viscometer and differential refractometer (the DRI detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for about 2 hours. All quantities are measured gravimetrically. The TCB densities used to express the polymer concentration in mass/volume units are 1.463 g/ml at room temperature and 1.284 g/ml at 145° C. The injection concentration is from 0.5 to 2.0 mg/ml, with lower concentrations being used for higher molecular weight samples. Prior to running each sample, the DRI detector and the viscometer are purged. Flow rate in the apparatus is then increased to 0.5 ml/minute, and the DRI is allowed to stabilize for 8 hours before injecting the first sample. The LS laser is turned on at least 1 to 1.5 hours before running the samples. The concentration, c, at each point in the chromatogram is calculated from the baseline-subtracted DRI signal, I_{DRI}, using the following equation:

c=K_{DRI}I_{DRI}/(dn/dc),

where K_{DRI} is a constant determined by calibrating the DRI, and (dn/dc) is the refractive index increment for the system. The refractive index, n=1.500 for TCB at 145° C. and a=690 nm. Units on parameters throughout this description of the GPC-3D method are such that concentration is expressed in g/cm³, molecular weight is expressed in g/mole, and intrinsic viscosity is expressed in dL/g.

The LS detector is a Wyatt Technology High Temperature DAWN HELEOS. The molecular weight, M, at each point in the chromatogram is determined by analyzing the LS output using the Zimm model for static light scattering (M. B. Huglin, Light Scattering From Polymer Solutions, Academic Press, 1971):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the DRI analysis, A₂ is the second virial coefficient. P(θ) is the form factor for a monodisperse random coil, and K_{O} is the optical constant for the system:

$${K}_{o} = \frac{4 {π}^{2} {{n}^{2} ( dn / d c )}^{2}}{{λ}^{4} {N}_{A}} ,$$

where N_{A} is Avogadro's number, and (dn/dc) is the refractive index increment for the system, which take the same value as the one obtained from DRI method. The refractive index, n=1.500 for TCB at 145° C. and λ=657 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, fs, for the solution flowing through the viscometer is calculated from their outputs. The intrinsic viscosity, [η], at each point in the chromatogram is calculated from the following equation:

ηₛ=c[η]+0.3(c[η])²,

where c is concentration and was determined from the DRI output.

### Reactors

In one or more embodiments, the polymerization mixtures may be formed within and the polymerization reaction conducted within a suitable reactor. In one or more embodiments, suitable reactors include continuous stirred tank reactors (CSTRs), continuous loop reactors with sufficient circulation rate, and boiling pool reactors. The process of the invention may employ one or more reactors. When more than one reactor is deployed in the process, they may be of the same or different reactor type, but at least one of the more than one reactors will be suitable for the process of the present invention. At least one of the reactors may accommodate a polymerization mixture maintained above the lower critical separation temperature and provide a liquid-liquid biphasic polymerization mixture maintained at steady state. Alternately or in combination, at least one of the reactors may accommodate a polymerization mixture maintained below the lower critical separation temperature and provide a single liquid phase homogeneous polymerization mixture maintained at steady state. At least one of the more than one reactors will produce the currently-disclosed types of LCB HDPE.

The reactors may be fully liquid filled. When more than one reactor is used, the reactors may operate at the same or different conditions with the same or different feeds. When more than one reactor is deployed in the process of the current disclosure, they may be of the same or different reactor type, but at least one of the more than one reactors will be suitable for the process of the current disclosure and will produce a polymer with narrow molecular weight distribution and with long-chain branching. They may be connected in series or in parallel, or any other combination when more than two reactors are employed.

### Reactor Polymerization Conditions

### Lower Critical Separation Temperature (LCST)

According to one or more embodiments, the polymerization mixture is maintained at a temperature and pressure above the lower critical separation temperature (LCST). As a result, the polymerization mixture is a liquid-liquid, biphasic reaction medium. Alternately, according to one or more embodiments, the polymerization mixture is maintained at a temperature and pressure below the lower critical separation temperature (LCST). As a result, the polymerization mixture is a single liquid phase reaction medium. For a given temperature value, the pressure that produces a liquid-liquid, biphasic reaction medium is lower than the pressure that produces a single liquid phase reaction medium. For a given pressure, the temperature that produces a liquid-liquid, biphasic reaction medium is higher than the pressure that produces a single liquid phase reaction medium. While the LCST of any given polymerization mixture can depend on several factors, such as the solvent used and the concentration of the monomer and polymer within the system, those having skill in the art can readily determine, without undue experimentation or calculation, the LCST of any given polymerization mixture at a specified pressure.

In one or more embodiments, the processes of the present invention include maintaining the polymerization mixture under a pressure of less than 70 atm, in other embodiments less than 60 atm, in other embodiments less than 50 atm, in other embodiments less than 45 atm, and in other embodiments less than 40 atm. In one or more embodiments, the processes of the present invention includes maintaining the polymerization mixture under a pressure of from about 40 to about 70 atm, in other embodiments from about 50 to about 68 atm, and in other embodiments from about 60 to about 65 atm.

In combination with the above-described pressures at which the polymerization mixture is maintained, the processes of the present invention includes maintaining the polymerization mixture at a temperature that is greater than 130° C., in other embodiments greater than 140° C., in other embodiments greater than 145° C., in other embodiments greater than 150° C., in other embodiments greater than 155° C., in other embodiments greater than 160° C., in other embodiments greater than 165° C., and in other embodiments greater than 170° C. In one or more embodiments, the polymerization mixture is maintained, in combination with the above-described pressures, in the temperature range of from about 130 to about 170° C., in other embodiments from about 150 to about 168° C., and in other embodiments from about 155 to about 165° C.

In certain embodiments, the solution processes of the current disclosure perform the polymerization of the ethylene at temperatures above the temperature at which the polymer forms a solid phase to keep the polymer dissolved in the polymerization medium and thus avoid reactor fouling. Specifically, the processes of the current disclosure operate at higher than 110° C., or higher than 120° C., or higher than 130° C., or higher than 140° C., or higher than 145° C., or higher than 150° C.

In certain embodiments, the pressure in the polymerization reactor could vary in a wide range, but generally is above 27.6 atm (400 psig), or above 34.5 atm (500 psig), or above 51.7 atm (750 psig), or above 69 atm (1,000 psig), or above 103.4 atm (1,500 psig). Advantageously, when the reactor temperature is selected from the higher ranges of the advantageous operating temperature window, the operating pressure is also chosen higher.

In certain embodiments, advantageous combinations of reactor temperature and pressure include above 110° C. with above 27.6 atm (400 psig), or above 120° C. with above 27.6 atm (400 psig), or above 120° C. with above 34.5 atm (500 psig), or above 130° C. with above 34.5 atm (500 psig), or above 140° C. with above 34.5 atm (500 psig), or above 145° C. with above 34.5 atm (500 psig), or above 150° C. with above 34.5 atm (500 psig), or any of the temperatures ranges with above 500° C., or any of the temperature ranges with 51.7 atm (750 psig), or any or the above temperature ranges with above 69 atm (1,000 psig), or any of the above temperature ranges with above 103.4 atm (1,500 psig).

### Steady State

According to aspects of the invention, the polymerization mixture is maintained under steady state conditions of temperature and pressure during polymerization of the monomer. Under steady-state conditions, all feed rates and feed and effluent compositions, as well as pressure and temperature are substantially constant. For purposes of this specification, steady state refers to maintaining substantially constant reactor feed and effluent compositions, temperature and pressure within a specified time domain (i.e. over a given period of time). In one or more embodiments, the time domain is the time duration in which the monomer undergoes polymerization. In these or other embodiments, the time domain is the residence time that the polymerization mixture is in the polymerization reactor. In these or other embodiments, this time duration refers to the time at which the polymerization mixture is above the LCST.

Relative to the meaning of steady state conditions, substantially constant temperature and pressure refers to maintaining the polymerization mixture within those temperature and pressure fluctuations that yield less than appreciable changes in the polymerization of monomer, especially with regard to the molecular weight distribution of the resulting polymer. In one or more embodiments, the temperature and pressure of polymerization mixture is maintained, with respect to the relevant time domain, at temperatures and pressures that have a relative percent difference of less than 10%, in other embodiments less than 8%, in other embodiments less than 6%, and in other embodiments less than 4%. Relative percent difference is calculated by obtaining two measurements (e.g. two temperature measurements) at two different times during the relative time domain (e.g. during the residence time of the polymerization), calculating the absolute difference, if any, between the measurements, dividing the difference by the average of the two measurements, and then multiplying by 100%. As an example, this calculation can be described for reactor temperature by the following formula:

|Δ|/ΣT/₂)×100%

where ΔT is T high−T low, and ΣT=T high+T low. T high and T low are, respectively, the highest and lowest temperatures measured at a given point in the reactor (e.g. in the bulk or at the exit port) during the relevant time domain.

In one or more embodiments, the polymerization mixture is maintained, over the relevant time domain (e.g. during the residence time within the polymerization reactor) so as to maintain temperature fluctuations of less than 15° C., in other embodiments less than 10° C., and in other embodiments less than 5° C. In these or other embodiments, the polymerization mixture is maintained, over the relevant time domain (e.g. during the residence time within the polymerization reactor), so as to maintain pressure fluctuations of less than 10 atm, in other embodiments less than 7 atm, and in other embodiments less than 4 atm.

The skilled person will be able to readily maintain the temperature and pressure of the polymerization mixture, during the relevant time domain, within the parameters of this invention without the exercise of undue calculation or experimentation. For example, conventional means exist to manipulate and maintain the pressure of a polymerization reactor such as a continuously-stirred tank reactor (CSTR). Likewise, the temperature can be controlled by employing conventional techniques such as, but not limited to, cooling jackets by adjusting the catalyst feed rate to the reactor, which adjusts the catalyst concentration in the reactor.

### Mixing

During the polymerization process, the polymerization mixture is mixed or otherwise agitated to achieve at least two polymerization mixture characteristics. First, the polymerization mixture is sufficiently mixed to achieve a polymerization mixture that has one or more uniform properties. Second, when the reaction medium is a liquid-liquid biphasic medium, the polymerization mixture is sufficiently mixed and/or agitated to achieve a fine dispersion of the first liquid domain within the second liquid domain of the liquid-liquid biphasic medium.

For purposes of this specification, the polymerization mixture is sufficiently mixed to achieve uniformity with respect to temperature. This includes the absence of a significant temperature gradient within the polymerization mixture in the reactor (i.e. relative to the spatial domain).

In one or more embodiments, the polymerization mixture is sufficiently agitated to achieve a relative percent difference for temperature, between any two locations within the polymerization mixture in the reactor, of less than 15%, in other embodiments less than 10%, and in other embodiments less than 5%. Relative percent difference is calculated by obtaining two measurements (e.g., temperature) at two different locations within the relevant spatial domain (i.e., within the reactor), determining the absolute difference, if any, between the measurements, dividing the difference by the average of the two measurements, and multiplying by 100%. Reference can be made to the above formula for calculating relative percent difference.

In one or more embodiments, the polymerization mixture is sufficiently mixed or otherwise maintained to achieve a relative percent difference in pressure, between any two locations within the polymerization mixture, of less than 10%, in other embodiments less than 6%, and in other embodiments less than 3%.

In one or more embodiments, the polymerization mixture is sufficiently mixed to achieve a relative percent difference in the concentration of dissolved or solubilized solids (e.g. catalyst, monomer, and polymer), between any two locations within the polymerization mixture, of less than 10%, in other embodiments less than 5%, and in other embodiments less than 3%.

As suggested above, mixing is also sufficient to provide a fine dispersion of the first liquid domain within the second liquid domain. In one or more embodiments, the first liquid domain, which is dispersed in the second liquid domain, has a size, which is the diameter or longest dimension of the domain, that is less than 1,000 μm, in other embodiments less than 100 μm, and in other embodiments less than 10 μm.

In one or more embodiments, the requisite mixing or agitation for practice of the present invention can be achieved by employing conventional mixing techniques. Indeed, those skilled in the art appreciate how to achieve well-mixed reactors. For example, mixing can be accomplished by employing mechanical agitators, by circulation through a loop reactor, or by the churn created by a boiling reaction medium.

It is understood by those of ordinary skill in the art that continuous stirred tank reactors and continuous loop reactors are illustrative of continuous reactors. In certain embodiments, the continuous reactor or boiling pool reactor ensures good mixing. In certain embodiments, a sufficient circulation rate ensure good mixing. In certain embodiments, the sufficient circulation rate is provided by an in-reactor loop flow rate/feed rate>4, or >5, or >6, or >7, or >8, or >9, or >10 weight/weight.

Processes of the current disclosure may use one or more continuous mixed reactors. Mixing can be accomplished either by using one or more stirrers, or by pumping around in a loop reactor, or by the churn created by the boiling reaction medium. The reactors may be fully liquid filled or may be partially filled with liquid, the second phase being a gas filled with the vapors in equilibrium with the liquid phase. When more than one reactor is used, the reactors may operate at the same or different conditions with the same or different feeds. When more than one reactor is deployed in the process of the current disclosure, they may be of the same or different reactor type, but at least one of the more than one reactors will be suitable for the process of the current disclosure and will produce LCB HDPE. They may be connected in series or in parallel, or any other combination when more than two reactors are employed.

### Reaction Medium

The reaction medium is a solution. The solution has the polymer in its dissolved phase and specifically not in its separated solid state even if it is split between two liquid phases. Thus, as used herein, “solution” refers to reaction conditions in solution and the “solution” may include one or more liquid phases including one or more liquids acting as solvents. The solution in a reactor may include a single liquid phase or may include a liquid-liquid biphasic system.

The processes of the current disclosure can be performed in a single liquid phase or in a liquid-liquid biphasic reaction medium. In all cases, however, the polymer is dissolved in the one or two liquid phases and thus does not form a separate solid phase, like, for example, in slurry polymerization. In this regard, the currently disclosed processes are solution polymerization processes even when two liquid phases are present in the reactor.

Liquid-liquid biphasic reaction media in the processes of this disclosure have two liquid phases. In liquid-liquid biphasic reaction media of this disclosure, one of the liquid phases is finely dispersed in the second, continuous liquid phase. The fine dispersion ensures no or very low concentration and temperature gradients in the dispersed liquid phase. Fine dispersion means that the size of the individual dispersed liquid domains are less than 1,000, or less than 100, or less than 10, or less than 1 micrometer. In most practical cases, the continuous phase is polymer lean, and the finely dispersed phase is polymer rich.

Although the reactor of the processes of the current disclosure may contain solid particles, those solid particles do not form in the reactor. However, the polymer is dissolved in the liquid phases present in the reactor, and is not separating as a solid phase. In this regard the disclosed polymerization is a solution polymerization process. Solid particles may be fed to the reactor for various reasons, for example the catalyst precursor and/or the activator or the active catalyst may be introduced as finely dispersed solid. Advantageously, the reactors of the present disclosure are free of solids and the catalyst is also dissolved, i.e., molecularly dispersed in the reaction medium. It will be understood by one of ordinary skill in the art, however, that being molecularly dispersed that is being dissolved, does not mean that the catalyst concentration must be the same in both liquid phases present in the reactor when the reaction medium is a liquid-liquid biphasic system. The same goes for all other components of the reaction medium present in the polymerization reactors of the currently disclosed processes.

The feed to the polymerization reactor employed in the process of the current disclosure advantageously comprises one or more solvent, or one or more solvent blends, a monomer and one or more comonomers, one single-site active catalyst or one single-site catalyst precursor and one catalyst activator. When the catalyst precursor and catalyst activator is not combined upstream of the reactor and thus fed as active catalyst to the reactor, the active catalyst is formed in the reactor by the reaction of the catalyst precursor and the catalyst activator. The feed advantageously contains one active catalyst, or one catalyst precursor in combination with one catalyst activator for easier process control and lower cost.

### Compositional Characteristics of Biphasic System

When polyolefins, and among them the currently-disclosed ethylene-based polyolefins are dissolved in various solvents, such as, for example, C₅-C₁₆ alkanes, cycloalkanes, aromatic hydrocarbons, partially or fully halogenated hydrocarbons, and their blends, the solutions may undergo liquid-liquid phase separation even while the polymers stay dissolve, i.e., molecularly dispersed in the medium. The result of this phase separation can be the formation of two bulk settled phases, or one of the two phases can be dispersed in the second continuous phase. The formation of the dispersed second liquid phase causes increased light scattering, thus this phase transition is often referred to as cloud point. The term cloud point, however, sometimes is also used to describe the precipitation of the solid polymer due to its crystallization. However, herein the term cloud point refers to the cloudy liquid state that is created upon liquid-liquid, not upon liquid-solid phase separation.

One of the phases forming as the result of the above-described phase separation may contain more polymer than the other. When light, low density solvents, such as, for example, C₅-C₈ open chain acyclic hydrocarbons are used, the polymer-rich phase has higher density than the polymer-lean phase.

It can be appreciated that when such phase separation occurs in the polymerization reactor, not only the concentration of the polymer, but the concentrations of the catalyst and/or monomers might also be different in the two phases for thermodynamic reasons and/or due to phase transfer limitations between the two liquid phases present in the reactor. Such concentration differences thus may essentially create two reaction zones with different reaction conditions even without temperature and/or bulk concentration gradients in the reactor resulting in the formation of polymer fractions with different molecular weights and monomer compositions. In essence, this would yield a blend of two polymer fractions with different average molecular weights from a single reactor. In the case of copolymers, this split would also apply to the compositions of the product polymer fractions as well. Since the two fractions would be blended during product recovery, this would broaden the molecular weight, and in the case of copolymers the composition distribution, of the polymer product recovered from the reactor.

The respective liquid phases of the liquid-liquid biphasic system may have unique compositional characteristics. In one or more embodiments, one phase may have a higher concentration of ethylene-based polyolefin relative to the second phase. In this regard, reference may be made to polymer-rich phase and polymer-lean phase, respectively. In one or more embodiments, the polymer-lean phase includes less than 10,000 ppm by weight, in other embodiments less than 5,000 ppm by weight, in other embodiments less than 1,000 ppm by weight, and in other embodiments less than 500 ppm by weight polymer (i.e., ethylene-based polyolefin). In these or other embodiments, the polymer-rich phase may include greater than 10, in other embodiments greater than 15, in other embodiments greater than 20, in other embodiments greater than 25, in other embodiments greater than 30, in other embodiments greater than 35, in other embodiments greater than 40% by weight polymer (i.e., ethylene-based polyolefin).

In one or more embodiments, the polymer-rich phase is the dispersed phase and the polymer-lean phase is the continuous phase of the liquid-liquid biphasic system.

In one or more embodiments, the polymer-rich phase and the polymer-lean phase generally have similar concentrations of monomer. In one or more embodiments, the respective monomer concentrations of the polymer-rich phase and the polymer-lean phase differ by less than 10 wt %, in other embodiments by less than 5 wt %, and in other embodiments by less than 1 wt %.

### Post-Polymerization Separation and Finishing

After the polymerization as described herein, the polymerization mixture is removed from the vessel in which the polymerization was conducted, and then the resultant ethylene-based polyolefin can be separated from the polymerization mixture (i.e. it is separated from the solvent and unreacted monomer). In one or more embodiments, once removed from the vessel in which the polymerization took place, the two or more polymerization mixtures (which include solutions of polymer) may be blended (i.e. solution blended off line). This may be particularly useful where multiple polymerization processes are conducted in series or in parallel. As the skilled person will appreciate, these polymer blends may be made for the purpose of improving polymer melt processability or for improving polymer performance for a particular use. For example, ethylene-based bimodal orthogonal composition distributions (BOCD) products, in which the high molecular weight (MW) component contains higher concentration of comonomers than the low MW component, are known to have improved crack resistance in injection molded products. These BOCD products can be made by blending a high MW component made in one reactor with a low MW component from another reactor. Similarly, melt processability of the polymers of the current disclosure can be improved by broadening the MWD by blending two components of different MW and/or by blending in at least one polymer component that has long-chain branching. Depending how close the molecular weights of the blend components are, the blends may or may not show bimodal (in case of two different blend components) or multimodal (in case of more than two different blend components) molecular weight and/or compositional distribution. When the components have similar MW and/or composition, the envelopes of their analytical traces may overlap so much that they appear to have a single component, though with broadened distribution. Nonetheless, they are bi- or multimodal in their essence even if the analytical techniques cannot clearly show it.

In any event, the polymerization mixture can be subjected to any conventional process for the separation of the polymer product from the solvent and monomer. For example, devolatization processes may include the use of devolatizing extruders, which typically heat and mechanically manipulate the polymerization mixture to separate the solvent and monomer as a volatiles stream. In one or more embodiments, this stream can be further treated or otherwise directly recycled back to the polymerization reactor.

### End Uses

The ethylene-based polyolefins of the present invention can be fabricated into various articles for a variety of uses. For example, the ethylene-based polyolefins can be injection molded or cast into films.

### Embodiments

Embodiments of the invention are directed toward a continuous process for preparing an ethylene-based polyolefin, the process comprising maintaining a polymerization mixture at a temperature at or above or below the lower critical phase separation temperature of the polymerization mixture, while, during said step of maintaining, maintaining the polymerization mixture at steady state, where the polymerization mixture is substantially uniform in temperature, pressure, and concentration, where the polymerization mixture includes solvent, monomer including ethylene and optionally monomer copolymerizable with ethylene, a single-site catalyst system, and polymer resulting from the polymerization of the monomer, where the monomer and the polymer are dissolved in the solvent, and where the polymer is an ethylene-based polyolefin having a molecular weight distribution (Mw/Mn) of less than 2.50, or less than 2.40, or less than 2.30.

Other embodiments of the invention are directed toward a method for preparing ethylene-based polyolefin, the method comprising (i) providing a polymerization vessel; (ii) continuously charging the polymerization vessel with monomer including ethylene and olefin monomer copolymerizable with ethylene, a solvent, and a single-site catalyst system, to thereby form a polymerization mixture; (iii) maintaining the polymerization mixture within the vessel at a temperature at or above or below the lower critical phase separation temperature of the polymerization mixture; (iv) mixing the polymerization within the vessel so that the temperature, pressure, and concentration of the polymerization mixture within the vessel is substantially uniform; and (v) continuously removing monomer, polymer formed by the polymerization of monomer, solvent, and single-site site catalyst system from the polymerization vessel at a rate substantially constant to the rate of continuously charging monomer, a solvent, and a single-site catalyst system, to thereby form a polymerization mixture, where the polymer continuously removed from the polymerization mixture is ethylene-based polyolefin having a molecular weight distribution of less than 2.50, or less than 2.40, or less than 2.30.

Still other embodiments of the invention are directed toward a polymeric solution comprising ethylene-based polyolefin dissolved in solvent at a temperature and pressure above the lower critical separation temperature of the polymer solution, where the ethylene-based polyolefin has a molecular weight distribution, Mw/Mn, of less than 2.5, or less than 2.4, or less than 2.3, where the solution is a biphasic solution including a first liquid phase including greater than 10 wt % ethylene-based polyolefin, based on the total weight of the first liquid phase, and a second liquid phase including less than 10,000 ppm ethylene-based polyolefin, based on the total weight of the second liquid phase.

### SPECIFIC EMBODIMENTS

Paragraph A: A continuous process for preparing an ethylene-based polyolefin, the process comprising maintaining a polymerization mixture at a temperature at or above the lower critical phase separation temperature of the polymerization mixture, while, during said step of maintaining, maintaining the polymerization mixture at steady state, where the polymerization mixture is substantially uniform in temperature, pressure, and concentration, where the polymerization mixture includes solvent, monomer including ethylene and optionally monomer copolymerizable with ethylene, a single-site catalyst system, and polymer resulting from the polymerization of the monomer, where the monomer and the polymer are dissolved in the solvent, and where the polymer is an ethylene-based polyolefin having a molecular weight distribution (Mw/Mn) of less than 2.30.

Paragraph B: The process of Paragraph A, where said step of maintaining a polymerization mixture includes maintaining the polymerization mixture at a pressure of less than 70 atm.

Paragraph C: The process of one or more of Paragraphs A and B, where said step of maintaining a polymerization mixture includes maintaining the polymerization mixture at a pressure of less than 50 atm.

Paragraph D: The process of one or more of Paragraphs A-C, where said step of maintaining a polymerization mixture includes maintaining the polymerization mixture at a temperature greater than 130° C.

Paragraph E: The process of one or more of Paragraphs A-D, where said step of maintaining a polymerization mixture includes maintaining the polymerization mixture at a temperature greater than 150° C.

Paragraph F: The process of one or more of Paragraphs A-E, where, during said step of maintaining, maintaining the polymerization mixture at temperature fluctuations of less than 15° C.

Paragraph G: The process of one or more of Paragraphs A-F, where, during said step of maintaining, maintaining the polymerization mixture at temperature fluctuations of less than 10° C.

Paragraph H: The process of one or more of Paragraphs A-G, where, during said step of maintaining, maintaining the polymerization mixture at pressure fluctuations of less than 10 atm.

Paragraph I: The process of one or more of Paragraphs A-H, where, during said step of maintaining, maintaining the polymerization mixture at pressure fluctuations of less than 7 atm.

Paragraph J: The process of one or more of Paragraphs A-I, where, during said step of maintaining, maintaining the temperature and pressure of the polymerization mixture at a relative percent difference of less than 10%.

Paragraph K: The process of one or more of Paragraphs A-J, where, during said step of maintaining, maintaining the temperature and pressure of the polymerization mixture at a relative percent difference of less than 6%.

Paragraph L: The process of one or more of Paragraphs A-K, where the ethylene-based polyolefin has a molecular weight distribution (Mw/Mn) of less than 2.25.

Paragraph M: The process of one or more of Paragraphs A-L, where the ethylene-based polyolefin has a molecular weight distribution (Mw/Mn) of less than 2.20.

Paragraph N: The process of one or more of Paragraphs A-M, where the single-site catalyst is prepared by combining a metallocene compound and an activator compound.

Paragraph O: The process of one or more of Paragraphs A-N, where the polymerization mixture is biphasic liquid-liquid system including a first liquid phase dispersed within a second liquid phase.

Paragraph P: The process of one or more of Paragraphs A-O, where the first liquid phase is in the form of liquid domains having a diameter of less than 1,000 μm.

Paragraph Q: The process of one or more of Paragraphs A-P, where the first liquid phase is in the form of liquid domains having a diameter of less than 100 μm.

Paragraph R: A method for preparing ethylene-based polyolefin, the method comprising (i) providing a polymerization vessel; (ii) continuously charging the polymerization vessel with monomer including ethylene and olefin monomer copolymerizable with ethylene, a solvent, and a single-site catalyst system, to thereby form a polymerization mixture; (iii) maintaining the polymerization mixture within the vessel at a temperature at or above the lower critical phase separation temperature of the polymerization mixture; (iv) mixing the polymerization mixture within the vessel so that the temperature, pressure, and concentration of the polymerization mixture within the vessel is substantially uniform; and (v) continuously removing monomer, polymer formed by the polymerization of monomer, solvent, and single-site site catalyst system from the polymerization vessel at a rate substantially constant to the rate of continuously charging monomer, a solvent, and a single-site catalyst system, where the polymer continuously removed from the polymerization mixture is ethylene-based polyolefin having a molecular weight distribution of less than 2.30.

Paragraph S: The method of Paragraph R, where said step of maintaining the polymerization mixture within the vessel includes maintaining the polymerization mixture at a temperature greater than 130° C.

Paragraph T: The method of one or more of Paragraphs R and S, further comprising the step maintaining the polymerization mixture within the vessel at a pressure of less than 70 atm.

Paragraph U: The method of one or more of Paragraphs R-T, where said step of mixing maintains the polymerization mixture within the vessel at a temperature and pressure at a relative percent difference of less than 10%, and where said step of mixing maintains the concentration of dissolved solids within the polymerization mixture at a relative percent difference of less than 10%.

Paragraph V: The method of one or more of Paragraphs R-U, where the ethylene-based polyolefin has a molecular weight distribution (Mw/Mn) of less than 2.25.

Paragraph W: The method of one or more of Paragraphs R-V, where the polymerization mixture is biphasic liquid-liquid system including a first liquid phase dispersed within a second liquid phase.

Paragraph X: The process of one or more of Paragraphs R-W, where the first liquid phase is in the form of liquid domains having a diameter of less than 1,000 μm.

Paragraph Y: The process of one or more of Paragraphs A-N, where the polymerization mixture is a single phase liquid system.

Paragraph Z: The process of one or more of Paragraphs A-Q, where the ethylene-based polyolefin has long-chain branching wherein on average a long-chain branch/polymer chain less than 10 and greater than 0.25.

Paragraph AA: A polymerization process comprising contacting an ethylene feed containing ethylene monomers with a catalyst feed containing a hafnium-based or zirconium-based single-site catalyst in a solution in a reactor so as to polymerize the ethylene monomers into long-chain branched high density polyethylene having on average a long-chain branch/polymer chain less than 10 and greater than 0.25.

Paragraph BB: The process of Paragraph AA, where the long-chain branched high density polyethylene has a molecular weight distribution less than 2.5 and greater than 2.0.

Paragraph CC: The process of one or more of Paragraphs AA-BB, where the long-chain branched high density polyethylene has a melt index (MI) less than 30 and greater than 0.1 g/10 min.

Paragraph DD: The process of one or more of Paragraphs AA-CC, where the long-chain branched high density polyethylene has a molecular weight greater than 42 kg/mol and less than 750 kg/mol.

Paragraph EE: The process of claim one or more of Paragraphs AA-DD, where the solution is a single-phase solution.

Paragraph FF: The process of one or more of Paragraphs AA-EE, where the solution is a bi-phasic solution having a polymer lean continuous phase and a polymer rich dispersed phase.

Paragraph GG: The process of one or more of Paragraphs AA-FF, where the single-site catalyst is formed from a catalyst precursor and an activator.

Paragraph HH: The process of Paragraph GG, where the single-site catalyst is a metallocene catalyst.

Paragraph II: The process of Paragraph HH, where the catalyst precursor is selected from the group consisting of dimethyl[(dimethylsilylene)bis[(1,2,3,3a,7a-h)-4,5,6,7-tetrahydro-1H-inden-1-ylidene]]-zirconium and dimethyl (μ-di(p-triethylsilylphenyl)silyl)(3,8-di-tert-butylfluorenylindenyl)hafnium, and the activator is selected from the group consisting of dimethylanilinium-tetrakis(perfluorophenyl)borate and dimethylanilinium-tetrakis(heptafluoronaphthyl)borate.

Paragraph JJ: The process of one or more of Paragraphs AA-II, where the reactor has an in-reactor loop flow rate/feed rate is greater than 4 weight/weight and less than 10.

Paragraph KK: The process of one or more of Paragraphs AA-JJ, where ethylene concentration in the reactor feed is between 5 and 40 wt % based on the total feed stream of the reactor.

Paragraph LL: The process of one or more of Paragraphs AA-KK, where the conversion of the ethylene monomers in the reactor is greater than 25% and less than 98%.

Paragraph MM: The process of one or more of Paragraphs AA-LL, where the solution is at a temperature greater than 110° C. and less than 200° C.

Paragraph NN: The process of one or more of Paragraphs AA-LL, where the solution is at a pressure is greater than 500 psig (3,400 kPa) and less than 3,000 psig (21,000 kPa).

Paragraph 00: The process of one or more of Paragraphs AA-MM, where the reactor is selected from the group consisting of continuous reactors and boil pool reactors.

Paragraph PP: The process of one or more of Paragraphs AA-NN, where an extensional viscosity response of the long-chain branched high density polyethylene shows strain hardening.

Paragraph QQ: A polymerization composition, comprising: ethylene; a hafnium-based or zirconium-based single-site catalyst; and a long-chain branched high density polyethylene polymerization product, where the long-chain branched high density polyethylene has on average a long-chain branch/polymer chain less than 10 and greater than 0.25; and where at least one of the ethylene, the catalyst, and the product is in solution.

Paragraph RR: The composition of Paragraph QQ, where the long-chain branched high density polyethylene has a molecular weight distribution less than 2.5 and greater than 2.0.

Paragraph SS: The composition of one or more of Paragraphs QQ-RR, where the long-chain branched high density polyethylene has a melt index (MI) less than 30 and greater than 0.1 g/10 min.

Paragraph TT: The process of one or more of Paragraphs QQ-SS, where the long-chain branched high density polyethylene has a molecular weight greater than 42 kg/mol and less than 750 kg/mol.

Paragraph UU: The process of claim one or more of Paragraphs QQ-TT, where the solution is a single-phase solution.

Paragraph VV: The process of one or more of Paragraphs QQ-UU, where the solution is a bi-phasic solution having a polymer lean continuous phase and a polymer rich dispersed phase.

Paragraph WW: The process of one or more of Paragraphs QQ-VV, where the single-site catalyst is formed from a catalyst precursor and an activator.

Paragraph XX: The process of Paragraph WW, where the single-site catalyst is a metallocene catalyst.

Paragraph YY: The process of Paragraph XX, where the catalyst precursor is selected from the group consisting of dimethyl[(dimethylsilylene)bis[(1,2,3,3a,7a-h)-4,5,6,7-tetrahydro-1H-inden-1-ylidene]]-zirconium and dimethyl (μ-di(p-triethylsilylphenyl)silyl)(3,8-di-tert-butylfluorenylindenyl)hafnium, and the activator is selected from the group consisting of dimethylanilinium-tetrakis(perfluorophenyl)borate and dimethylanilinium-tetrakis(heptafluoronaphthyl)borate.

Paragraph ZZ: The composition of one or more of Paragraphs QQ-YY, where the reactor has an in-reactor loop flow rate/feed rate is greater than 4 weight/weight and less than 10.

Paragraph AAA: The composition of one or more of Paragraphs QQ-ZZ, where ethylene concentration in the reactor feed is between 5 and 40 wt % based on the total feed stream of the reactor.

Paragraph BBB: The composition of one or more of Paragraphs QQ-AAA, where the conversion of the ethylene monomers in the reactor is greater than 25% and less than 98%.

Paragraph CCC: The composition of one or more of Paragraphs QQ-BBB, wherein the solution is at a temperature greater than 110° C. and less than 200° C.

Paragraph DDD: The composition of one or more of Paragraphs QQ-CCC, where the solution is at a pressure is greater than 500 psig (3,400 kPa) and less than 3,000 psig (21,000 kPa).

Paragraph EEE: The composition of one or more of Paragraphs QQ-DDD, where the reactor is selected from the group consisting of continuous reactors and boil pool reactors.

Paragraph FFF: The composition of one or more of Paragraphs QQ-EEE, where an extensional viscosity response of the long-chain branched high density polyethylene shows strain hardening.

To facilitate a better understanding of the present disclosure, the following examples are given. The examples should not, however, be viewed as limiting the scope of the disclosure or claims. The claims will serve to define the invention.

### EXAMPLES

### General Procedures

### Laboratory Testing of Polymerization Process

All polymerizations were performed in a continuous stirred tank reactor (CSTR) made by Autoclave Engineers, Erie Pa. The reactor was designed to operate at a maximum pressure and temperature of 2,000 bar (30 kpsi) and 225° C., respectively. The nominal reactor vessel volume was 150 mL. The reactor was equipped with a magnetically coupled mechanical stirrer (Magnedrive). A pressure transducer measured the pressure in the reactor. The reactor temperature was measured using two type-K thermocouples. The reported values are the averages of the two readings. A flush-mounted rupture disk located on the side of the reactor provided protection against catastrophic pressure failure. All product lines were heated to ˜120-150° C. to prevent fouling. The reactor had an electric heating band that was controlled by a programmable logic control (PLC) computer to maintain the desired reactor temperature. Except for the heat losses to the environment, the reactor did not have cooling (nearly adiabatic operations).

The conversion in the reactor was monitored by an on-line gas chromatograph (GC) that sampled both the feed and the effluent. The GC analysis utilized the ethane impurity present in the ethylene feed as internal standard.

Feed purification traps were used to control impurities carried by the monomer feed. The purification traps were placed before the ethylene feed compressor and comprised of two separate beds in series: activated copper (reduced in flowing H₂ at 225° C. and 1 bar) for 02 removal followed by a molecular sieve (5A, activated in flowing N₂ at 270° C.) for water removal.

Purified liquid monomer feed was fed by a single-barrel ISCO pump (model 500D) in neat form or diluted by the same solvent as used in polymerization. The liquid monomer feeds were purified by filtration through an activated basic alumina bed followed by the addition of −3 mL of trioctylaluminum solution (Aldrich #38,655-3)/2 L of liquid monomer feed.

The catalyst feed solution was prepared inside an argon-filled dry box (Vacuum Atmospheres). The atmosphere in the glove box was purified to maintain <1 ppm 02 and <1 ppm water. All glassware was oven-dried for a minimum of at least 4 hours at 110° C. and transferred hot to the antechamber of the dry box before bringing them to the box. Stock solutions of the catalyst precursor and the activator were prepared using purified toluene that was stored in amber bottles inside the dry box. Aliquots were taken to prepare fresh activated catalyst solutions. The activated catalyst solution was charged inside the argon-filled dry box to a heavy-walled glass reservoir (Ace Glass, Inc. Vineland, N.J.) and was pressurized to 5 psig with argon to send it to the catalyst feed pump in a closed line. The activated catalyst solution was delivered to the unit by a two-barrel continuous high-pressure syringe pump (PDC Machines).

HPLC grade hexane (95% n-hexane, J. T. Baker) or isohexane (South Hampton Resources, Dallas, Tex.) was used as solvent. It was purged with argon for a minimum of four hours and was sent through an activated copper and a molecular sieve (5A) bed, then filtered once over activated basic alumina. The filtered hexane or isohexane was stored in a heavy-wall 4-liter glass vessel (Ace Glass, Vineland, N.J.) inside an argon-filled dry box. The solvent feed was further purified by adding ˜3-5 mL of trioctylaluminum solution (Aldrich #38,655-3) to the 4-liter reservoir of filtered hexane. 5-10 psig head pressure of argon was applied to the glass vessel to send the scavenger-containing hexane to a metal feed vessel from which the hexane was delivered to the reactor by a two-barrel continuous ISCO pump (model 500D).

During the polymerizations, the reactor was first preheated to ˜10-15° C. below that of the desired reaction temperature. Once the reactor reached the preheat temperature, the solvent pump was turned on to feed the solvent to the reactor. This solvent stream entered the reactor through a port on the top of the stirrer assembly to keep the polymer from fouling the stirrer. The monomers were fed to the reactor through a single side port. The activated catalyst solution was fed by syringe pump. The catalyst solution was mixed with the stream of flowing solvent upstream of the reactor. During the reactor line-out period the catalyst feed rate was adjusted to reach and maintain the target monomer conversion, the latter of which monitored by GC sampling. After establishing steady state reactor conditions during which all process parameters, feed rates, and monomer conversions were constant, the products were collected in a dedicated collection vessel for a time sufficient to collect the desired amounts of product. This stage of the run was called the balance period as it was used to collect the product while measuring and recording the exact feed flow rates and the length of the run. The polymer made during the balance period under steady state conditions was collected at the end of each run and weighed after vacuum-drying overnight at 50-70° C. The total feed during the balance period combined with the product yield and composition data were used to compute monomer concentrations and monomer conversions. Aliquots of the products were used for characterization without homogenizing the entire product yield.

### DSC Analysis

The heat associated with phase transitions was measured on heating and cooling the polymer samples from the solid state and melt, respectively, using a TA Instruments Discovery series DSC. The data were analyzed using the analysis software provided by the vendor. Typically, 3 to 10 mg of polymer was placed in an aluminum pan and loaded into the instrument at room temperature. The sample was cooled to −40° C. and then heated to 210° C. at a heating rate of 10° C./min to evaluate the glass transition and melting behavior for the as-received polymers. Crystallization behavior was evaluated by cooling the sample from 210 to −40° C. at a cooling rate of 10° C./min. Second heating data were measured by heating this melt-crystallized sample at 10° C./min. The second heating data thus provide phase behavior information for samples crystallized under controlled thermal history. The endothermic melting transition (first and second melt) and exothermic crystallization transition were analyzed for onset of transition and peak temperature. The melting temperatures are the peak melting temperatures from the second melt unless otherwise indicated. Areas under the DSC curve were used to determine the heat of fusion (ΔH_{f}).

### Melt Index (MI)

The Melt Flow Rate (MFR) of the polymers was determined by using Dynisco Kayeness Polymer Test Systems Series 4003 apparatus following ASTM D1238 and ISO 1133 methods. The protocol for the measurement is described in the Series 4000 Melt Indexer Operation manual, Method B.

### Gel Permeation Chromatography (GPC)

The molecular weights and Mw/Mn values were determined using GPC with triple detector using techniques described hereinabove. Specifically, the instrument was an Agilent PL 220 GPC pump and auto liquid sampler with the Wyatt HELEOS-II detector system, 10 μm PD; the column was a 3 PLGel Mixed “B” (linear range from 500 to 10,000,000 MW PS) having a length of 300 mm and an I.D. of 7.5 mm; the three detectors, which were in series, included 18 angles light-scattering (LS), differential refractive index (DRI), and Viscometer; the solvent program was 1.0 ml/min inhibited TCB (1,500 ppm BHT 2,4-tert-butyl-6-methyl phenol in 1,2,3-trichlorobenzene; the column, detector and injector were set at 145° C.

### Rheology

Dynamic shear melt rheological data was measured with an Advanced Rheometrics Expansion System (ARES) using parallel plates (diameter=25 mm) in a dynamic mode under nitrogen atmosphere. For all experiments, the rheometer was thermally stable at 150° C. for at least 30 minutes before inserting compression-molded sample of resin onto the parallel plates. To determine the samples viscoelastic behavior, frequency sweeps in the range from 0.01 to 100 rad/s were carried out at a temperature of 190° C. under constant strain. Depending on the molecular weight and temperature, a strain of 10% was used and the linearity of the response was verified. A nitrogen stream was circulated through the sample oven to minimize chain oxidation or cross-linking during the experiments. All the samples were compression molded at 190° C. and stabilizers were added. A sinusoidal shear strain is applied to the material if the strain amplitude is sufficiently small the material behaves linearly. It can be shown that the resulting steady-state stress will also oscillate sinusoidally at the same frequency, but will be shifted by a phase angle δ with respect to the strain wave. The stress leads the strain by 8. For purely elastic materials δ=0° (stress is in phase with strain) and for purely viscous materials, δ=90° (stress leads the strain by 90° although the stress is in phase with the strain rate). For viscoelastic materials, 0<δ<90.

The transient uniaxial extensional viscosity was measured using a SER-2-A Testing Platform available from Xpansion Instruments LLC, Tallmadge, Ohio, USA. The SER Testing Platform was used on a Rheometrics ARES-LS (RSA3) strain-controlled rotational rheometer available from TA Instruments Inc., New Castle, Del., USA. The SER Testing Platform is described in U.S. Pat. No. 6,578,413 & 6,691,569, which are incorporated herein for reference. A general description of transient uniaxial extensional viscosity measurements is provided, for example, in “Strain hardening of various polyolefins in uniaxial elongational flow,” The Society of Rheology, Inc., J. Rheol., v.47(3), (2003) p. 619-630; and “Measuring the transient extensional rheology of polyethylene melts using the SER universal testing platform”, The Society of Rheology, Inc., J. Rheol., v.49(3), (2005) p. 585-606, incorporated herein for reference strain hardening occurs when a polymer is subjected to uniaxial extension and the transient extensional viscosity increases more than what is predicted from linear viscoelastic theory. Strain hardening is observed as an abrupt upswing of the extensional viscosity in the transient extensional viscosity vs. time plot. This abrupt upswing, away from the behavior of a linear viscoelastic material, was reported in the 1960s for LDPE (reference: J. Meissner, Rheology Acta., v.8, (1969) p. 78) and was attributed to the presence of long branches in the polymer. A strain hardening ratio (SHR) is used to characterize the upswing in extensional viscosity and is defined as the ratio of the maximum transient extensional viscosity over three times the value of the transient zero-shear-rate viscosity at the same strain. Strain hardening is present in the material when the ratio is greater than 1.

Rheological data was presented by plotting the phase angle versus the absolute value of the complex shear modulus (G*) to produce a van Gurp-Palmen plot. It is known to one of ordinary skill in the art that the plot of conventional polymers shows monotonic behavior and a negative slope toward higher G* values. Conventional polymers without long-chain branches exhibit a negative slope on the van Gurp-Palmen plot. For branched polymers, the phase angles shift to a lower value as compared with the phase angle of a conventional polymer without long-chain branches at the same value of G*.

Branched structures were observed by Small Amplitude Oscillatory Shear (SAOS) measurement of the molten polymer performed on a dynamic (oscillatory) rotational rheometer. From the data generated by such a test it was possible to determine the phase or loss angle δ, which is the inverse tangent of the ratio of G″ (the loss modulus) to G′ (the storage modulus). It is known to one of ordinary skill in the art tat for a typical linear polymer, the loss angle at low frequencies (or long times) approaches 90 degrees, because the chains can relax in the melt, absorbing energy, and making the loss modulus much larger than the storage modulus. As frequencies increase, more of the chains relax too slowly to absorb energy during the oscillations, and the storage modulus grows relative to the loss modulus. Eventually, the storage and loss moduli become equal and the loss angle reaches 45 degrees. In contrast, a branched chain polymer relaxes very slowly, because the branches need to retract first before the chain backbone can relax along its tube in the melt. This polymer never reaches a state where all its chains can relax during an oscillation, and the loss angle never reaches 90 degrees even at the lowest frequency, ω, of the experiments. The loss angle is also relatively independent of the frequency of the oscillations in the SAOS experiment; another indication that the chains cannot relax on these timescales.

### Mathematical Modeling of Polymerization Medium

In the foregoing samples, the characterization of the polymerization medium was modeled to determine whether the reaction conditions created a single phase liquid solution or a liquid-liquid biphasic solution. In performing this analysis, the feed monomer content, flow rate, and reactor productivity were maintained within a tight range, which ensured comparable reactor compositions. Two reactor pressures, nominally about 40.8 and about 115.7 atm (41 and 117 bar, respectively), were used to switch between biphasic liquid and single phase liquid.

The variant of the statistical associating fluid theory (SAFT) that was used to predict the phase diagrams was SAFT-1, which is described in H. Adidharma and M. Radosz (1998) Ind. Eng. Chem. Res., v.37, pp. 4453-4462. To calculate the phase boundaries, the tangent plane criterion was applied to the Gibbs free energy as defined by SAFT-1:

$${G}_{Mix} ( {{x}^{\overline{ω}}}_{Feed} + Δ {x}^{\overline{ω}} ) - {G}_{Mix} ( {{x}^{\overline{ω}}}_{Feed} ) - ▽ G ( {{x}^{\overline{ω}}}_{Feed} ) \cdot Δ {x}^{\overline{ω}} \geq 0 \\ {x}^{\overline{ω}} = Feed Composition \\ Δ {x}^{\overline{ω}} = All possible mixtures$$

For the polyethylene component, the SAFT-1 parameters were used (H. Adidharma and M. Radosz (1998) Ind. Eng. Chem. Res., v.37, pp. 4453-4462):

m=0.023763×Mn+0.618823

v^{∞}=(0.599110×Mn+4.640260)/m

μ^{o}/k_{B}=(6.702340×Mn+19.67793)/m

λ^{o}(0.03930×Mn+1.104297)/m

where Mn is the number average molecular weight and the SAFT-1 parameters are defined in the reference above. For the small molecules, the values reported in Table 1 below were used, which values were obtained by Supercritical Fluids Inc. (Wyoming). Octane SAFT-1 parameters were used for octene.

Cloud point experiments, which were conducted by using the HDPE control NIST 1484 Supercritical Fluids, established that the polyethylene/isohexane kᵢⱼ interaction parameter is −0.00433; and the polyethylene/propylene interaction parameter is 0.032269-5.34E-5T; and the isohexane/propylene parameter is −0.01. It was assumed that ethylene had equivalent interaction parameters as propylene, and based upon this assumption, the parameters in the Table 2 below were used for ethylene. Interaction parameters not listed in Table 2 were assumed to be zero.

TABLE 1
SAFT-1 parameters for small molecules

| | Molecular | | | | |
|---|---|---|---|---|---|
| Component | Weight | M | v^{∞} = N_{A}σ³/\sqrt{2} | μ^{o}/k_{B} | λ^{o} |
| Isohexane | 86.18 | 2.5666 | 21.7896 | 220.1542 | 1.6907 |
| Ethylene | 44.1 | 1.4578 | 13.9127 | 138.8488 | 1.7535 |
| Octane | 114.23 | 3.333 | 21.897 | 236.923 | 1.6758 |
| Toluene | 92.14 | 2.182 | 21.969 | 307.801 | 1.6442 |

TABLE 2
SAFT-1 interaction parameters required to calculate
the dispersion term

| Component 1 | Component 2 | kᵢⱼ intercept | kᵢⱼ slope |
|---|---|---|---|
| Polyethylene | Isohexane | −0.00433 | 0 |
| Polyethylene | Ethylene | 0.032269 | −5.34E-05 |
| Isohexane | Ethylene | −0.01 | 0 |

### SPECIFIC EXAMPLES

### Example 1. Controlled MWd-Ethylene-Octene Copolymerization

Ethylene-based polyolefins were prepared in isohexane. In certain samples, the polymerization mixtures were maintained above the LCST, and in other samples the mixtures were maintained below the LCST.

While the polymerization mixture for all samples was generally maintained between 150 and 170° C., a first series of polymerization samples was conducted at 600 psi (40.8 atm) nominal pressure, which created a liquid-liquid biphasic polymerization mixture above the LCST, and a second series of polymerization samples was conducted at 1,700 psi (115.7 atm) nominal pressure, which create a single-phase polymerization mixture below the LCST. The relevant data from the polymerization samples above the LCST (i.e. the liquid-liquid biphasic polymerization mixture) is reported in Tables 3A-3C, and the relevant data from the polymerization samples below the LCST (i.e., the single-phase polymerization mixture) is reported in Tables 4A-4C.

The polymerizations were conducted using a single-site catalyst that was prepared as a pre-formed activated catalyst by combining dimethyl-(m-di(p-triethylsilylphenyl)silyl)(3,8-di-tert-butylfluorenyl-indenyl)hafnium transition metal precursor with dimethylanilinium-tetrakis(pentafluorophenyl)borate activator precursor.

TABLE 3A
Liquid-liquid biphasic solution—controlled MWD

| | Reactor Conditions | | | | | |
|---|---|---|---|---|---|---|
| | Reactor Temperature | | | | | |
| | | | | | Above | |
| | | | | | (+) or | |
| | | | ΔT = | | Below | |
| | | | lower − | | (−) the | |
| | Upper | Lower | upper | avg. | LCST | Press. |
| Sample # | ° C. | ° C. | ° C. | ° C. | ° C. | atm |
| 26933-047 | 157 | 153 | −4 | 155 | 12 | 43.2 |
| 26933-053 | 166 | 164 | −2 | 165 | −2 | 44.0 |
| 26933-054 | 166 | 164 | −1 | 165 | 3 | 44.0 |
| 26933-055 | 166 | 164 | −2 | 165 | 8 | 43.8 |
| 26933-041 | 156 | 154 | −2 | 155 | 23 | 41.1 |
| 26933-042 | 158 | 152 | −6 | 155 | 5 | 39.9 |
| 26933-048 | 157 | 153 | −4 | 155 | 6 | 42.6 |
| 26933-049 | 156 | 154 | −2 | 155 | −2 | 42.1 |
| 26933-050 | 157 | 153 | −4 | 155 | 4 | 42.1 |

TABLE 3B
Liquid-liquid biphasic solution—controlled MWD

| | Reactor Conditions | | | | | | |
|---|---|---|---|---|---|---|---|
| | | | | | Octene-1 | | |
| | | Total | C₂ = Feed | | feed | | Polymer |
| | C₈F₁₈ | Solvent | (solvent | | (solvent | | in the |
| | Feed | Feed | included) | | included) | | Reactor |
| Sample # | wt % | wt % | g/min | wt % | g/min | wt % | wt % |
| 26933-047 | 0.0182 | 88.4 | 1.10 | 11.59 | 0.000 | 0.000 | 10.7 |
| 26933-053 | 0.021 | 88.4 | 1.10 | 11.59 | 0.000 | 0.000 | 10.8 |
| 26933-054 | 0.0217 | 91.3 | 0.80 | 8.70 | 0.000 | 0.000 | 8.1 |
| 26933-055 | 0.0217 | 91.3 | 0.80 | 8.71 | 0.000 | 0.000 | 8.0 |
| 26933-041 | 0.0125 | 87.8 | 1.10 | 11.52 | 0.063 | 0.66 | 9.9 |
| 26933-042 | 0.0125 | 87.8 | 1.10 | 11.51 | 0.063 | 0.659 | 11.7 |
| 26933-048 | 0.0126 | 88.3 | 1.10 | 11.58 | 0.016 | 0.168 | 11.1 |
| 26933-049 | 0.0181 | 88.2 | 1.10 | 11.56 | 0.023 | 0.242 | 11.3 |
| 26933-050 | 0.0182 | 88.2 | 1.10 | 11.57 | 0.023 | 0.242 | 11 |

TABLE 3C
Liquid-liquid biphasic solution—controlled MWD

| | Product | | | | | | |
|---|---|---|---|---|---|---|---|
| | | | | | | Mw | Mw/Mn |
| | | Melting (first) | | Melting (second) | | by LS | by DRI |
| | MI | Peak | ΔH_{f} | Peak | ΔH_{f} | By GPC | |
| Sample # | g/10 min | ° C. | J/g | ° C. | J/g | kg/mol | - |
| 26933-047 | 3.1 | 126.0 | 146.2 | 127.5 | 174.4 | 65.29 | 2.01 |
| 26933-053 | 291.5 | 122.7 | 166 | 123.7 | 186.6 | 19.95 | 2.32 |
| 26933-054 | 68.9 | 123 | 169.7 | 123.7 | 187.3 | 24.91 | 2.38 |
| 26933-055 | 104.8 | 123.3 | 164.8 | 124.5 | 188.2 | 28.87 | 2.23 |
| 26933-041 | 38.7 | 115.4 | 114.6 | 114.8 | 135.7 | 40.22 | 2.09 |
| 26933-042 | 23.1 | 115.8 | 121.6 | 115.3 | 137.3 | 40.27 | 2.18 |
| 26933-048 | 1.8 | 123.1 | 136.8 | 124.3 | 157.7 | 55.02 | 2.09 |
| 26933-049 | 83.8 | 121.2 | 145.7 | 121.3 | 160.9 | 38.14 | 2.06 |
| 26933-050 | 12.9 | 121.7 | 130.0 | 122.6 | 149.8 | 47.64 | 2.01 |

TABLE 4A
Single liquid phase solution - controlled MWD

| | Reactor Conditions | | | | |
|---|---|---|---|---|---|
| | Reactor Temperature | | | | |
| | | | ΔT = | | |
| | | | lower- | | |
| | Upper | Lower | upper | avg. | Press. |
| Sample # | ° C. | ° C. | ° C. | ° C. | Atm |
| 26933-056 | 157 | 154 | −3 | 155 | 115.6 |
| 26933-057 | 157 | 154 | −3 | 155 | 116.8 |
| 26933-058 | 156 | 154 | −3 | 155 | 118.5 |
| 26933-059 | 156 | 154 | −2 | 155 | 116.9 |
| 26933-060 | 156 | 154 | −2 | 155 | 115.6 |
| 26933-061 | 156 | 154 | −3 | 155 | 118.5 |
| 26933-044 | 158 | 152 | −6 | 155 | 116.5 |

TABLE 4B
Single liquid phase solution—controlled MWD

| | Reactor Conditions | | | | | | |
|---|---|---|---|---|---|---|---|
| | | Total | C₂ = Feed | | Octene-1 feed | | |
| | C₈F₁₈ | Solvent | (solvent | | (solvent | | Polymer |
| | Feed | Feed | included) | | included) | | Cement |
| Sample # | wt % | wt % | g/min | wt % | g/min | wt % | wt % |
| 26933-056 | 0.0184 | 88.4 | 1.10 | 11.59 | 0.000 | 0.000 | 10.9 |
| 26933-057 | 0.0184 | 88.4 | 1.10 | 11.59 | 0.000 | 0.000 | 11.0 |
| 26933-058 | 0.0184 | 88.4 | 1.10 | 11.59 | 0.000 | 0.000 | 10.9 |
| 26933-059 | 0.0184 | 88.4 | 1.10 | 11.58 | 0.000 | 0.000 | 11.2 |
| 26933-060 | 0.0184 | 88.4 | 1.10 | 11.59 | 0.000 | 0.000 | 11.0 |
| 26933-061 | 0.0184 | 88.4 | 1.10 | 11.59 | 0.000 | 0.000 | 11.1 |
| 26933-044 | 0.0184 | 88.2 | 1.10 | 11.57 | 0.023 | 0.242 | 11.4 |

TABLE 4C
Single liquid phase solution—controlled MWD

| | Product | | | | | | |
|---|---|---|---|---|---|---|---|
| | | Melting | | Melting | | Mw by | Mw/Mn |
| | | (first) | | (second) | | LS | by DRI |
| | MI | Peak | ΔH_{f} | Peak | ΔH_{f} | By GPC | |
| Sample # | g/10 min | ° C. | J/g | ° C. | J/g | kg/mol | |
| 26933-056 | 4.7 | 125.1 | 148.9 | 127.2 | 175.0 | 40.000 | 2.22 |
| 26933-057 | 21.4 | 124.1 | 155.9 | 125.4 | 182.0 | 38.731 | 2.16 |
| 26933-058 | 26.9 | 124.6 | 150.6 | 126.2 | 180.1 | 38.403 | 2.16 |
| 26933-059 | 12.5 | 124.6 | 149.5 | 126.3 | 176.6 | 48.630 | 2.13 |
| 26933-060 | 41.9 | 123.9 | 157.4 | 125.1 | 183.4 | 31.917 | 2.02 |
| 26933-061 | 48.3 | 124.6 | 147.9 | 126.3 | 117.1 | 34.767 | 2.05 |
| 26933-044 | 22.7 | 118.8 | 127.8 | 118.8 | 145.8 | 40.419 | 2.14 |

### Example 2. Ethylene Homopolymerization

To demonstrate the novel solution polymerization process that yield LCB HDPE both in a single liquid and in a liquid-liquid biphasic polymerization medium, polymerizations at nominally 41.4 and 110.3-117.2 atm (600 and 1,600-1,700 psig) were performed. Examples for producing inventive polyethylene products are given in Tables 5A-5C below.

The examples in Tables 5A-5C in combination with rheology and ¹³C NMR data (vide infra) demonstrate that a solution polymerization process run at the currently disclosed advantageous conditions with properly selected catalysts can produce LCB HDPE. Comparative samples (out of scope conditions and products) in Table 5 in combination with rheology and ¹³C NMR data (vide infra) also demonstrate that when the HDPE products made are too light (less than 42 kg/mol Mw or correspondingly, more than 30 g/10 min MI) the products do not show improved melt rheology, i.e., they do not have enhanced shear-thinning, even with the catalysts that at the properly set conditions do make products with improved shear-thinning.

The polymerizations were conducted using a single-site catalyst that was prepared as a pre-formed activated catalyst by combining a transition metal precursor with an activator. The transition metal precursor included a metal and a ligand. In Table 5A, F3 indicates μ-di(p-triethylsilylphenyl)silyl)(3,8-di-tert-butylfluorenylindenyl ligand, S indicates (dimethylsilylene)bis[(1,2,3,3a,7a-h)-4,5,6,7-tetrahydro-1H-ind en-1-ylidene ligand, Zr indicates zirconium, Hf indicates hafnium, and D4 indicates dimethylanilinium-tetrakis(perfluorophenyl)borate activator.

### Example 3. Ethylene-Octene Copolymerization

The examples in Tables 6A-6C demonstrate the high incorporation rate of octene-1 and meet the herein specified requirements. Tables 6A-6C shows results demonstrating the desired incorporation ratio of octene-1 for the advantageously selected catalysts S-Zr-D4 and F3-Hf-D4 catalysts.

The polymerizations were conducted using a single-site catalyst that was prepared as a pre-formed activated catalyst by combining a transition metal precursor with an activator. The transition metal precursor included a metal and a ligand. In Table 6A, F3 indicates μ-di(p-triethylsilylphenyl)silyl)(3,8-di-tert-butylfluorenylindenyl ligand, S indicates (dimethylsilylene)bis[(1,2,3,3a,7a-h)-4,5,6,7-tetrahydro-1H-ind en-1-ylidene ligand, Zr indicates zirconium, Hf indicates hafnium, and D4 indicates dimethylanilinium-tetrakis(perfluorophenyl)borate activator.

### Example 4. SAFT Modeling

Our SAFT model results indicated that all runs listed in Table 5 that were performed at 1,700 psi fell in the single liquid phase regime since even the 155° C. run temperature was at least 50° C. below the lower critical phase separation temperature (LCST). On the other hand, the runs performed at the nominal 600 psi reactor pressure were most often above the LCST and thus the polymers were made in a liquid-liquid biphasic reaction medium.

### Example 5. Rheological Testing—Extensional Viscosity Response

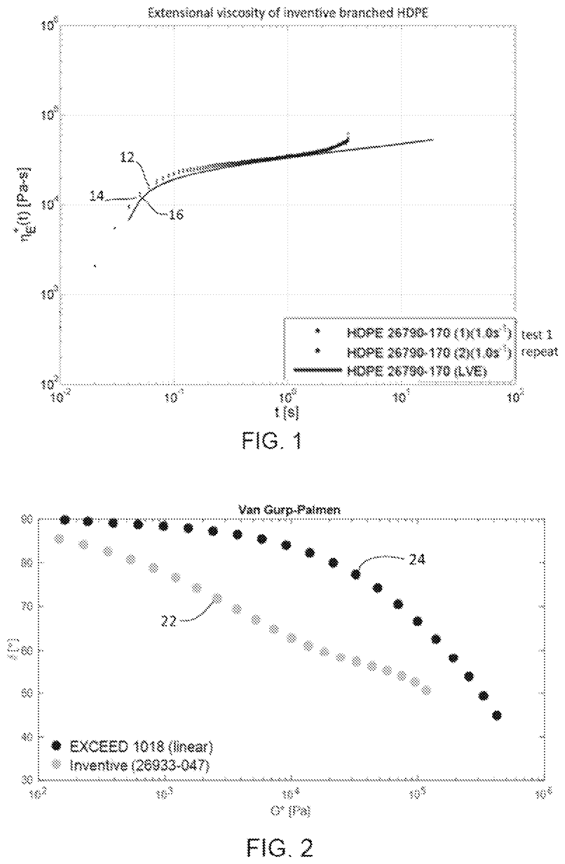

FIG. 1 shows, as an example, the extensional viscosity response of the inventive HDPE 26790-170. Two test runs of results for HDPE 26790-170 are shown, HDPE 26790-170 (1) 12 and HDPE 26790-170 (2) 14, with data points for each run indicated by circles, as compared to a reference HDPE 26790-170 (LVE) 16, indicated by a straight line. It can be seen from the two runs that the results for the inventive HDPE 26790-170 are reproducible. The upturn in viscosity at about 3 seconds indicates the presence of strain hardening in the resin, which is a direct rheological indication of long-chain branching (LCB). This direct measurement of long-chain branching was not always possible for all the samples listed in Tables 5A-5C due to sample sagging. Since sagging creates measurement problems in extensional rheology testing, the zero-shear-rate viscosity of the sample needs to be higher than 10,000 Pa·s.

### Example 6. Rheological Testing—Van-Gurp-Palmen Representations

For lower viscosity samples, where this condition was not met and thus sagging occurred, shear rheology and Van-Gurp-Palmen representations was used to detect the presence of long-chain branching. FIG. 2 shows the Van-Gurp-Palmen plot of the inventive HDPE resin 26933-047 22 compared to a linear reference (Exceed 1018) 24. The inflexion point in the 26933-047 curve 22 signals the presence of long-chain branching.

TABLE 5A
Ethylene homopolymerization - controlled MWD and LCB

| | Catalyst | | | Reactor | |
|---|---|---|---|---|---|
| | Ligand | Metal | Activator | Conditions | |
| | Type | Type | Type | Temp. | Press. |
| Sample # | — | — | — | ° C. | Psig. |

Inventive:

| | | | | | |
|---|---|---|---|---|---|
| 26790-170 | S | Zr | D4 | 114 | 1613 |
| 26790-184 | S | Zr | D4 | 113 | 1612 |
| 26790-119 | S | Zr | D4 | 130 | 1736 |
| 26790-120 | S | Zr | D4 | 131 | 1716 |
| 26790-046 | F3 | Hf | D4 | 155 | 1724 |
| 26790-047 | F3 | Hf | D4 | 155 | 635 |

Comparative:

| | | | | | |
|---|---|---|---|---|---|
| 26790-178 | S | Zr | D4 | 112 | 1634 |
| 26790-089 | S | Zr | D4 | 130 | 1727 |
| 26790-107 | S | Zr | D4 | 130 | 1713 |
| 26790-108 | S | Zr | D4 | 130 | 1733 |

TABLE 5B
Ethylene homopolymerization—controlled MWD and LCB

| | Reactor Conditions | | | | | | |
|---|---|---|---|---|---|---|---|
| | | | Catalyst | | | | |
| | | | solution | C₂ = feed | | | |
| | Solvent feed | | (toluene) | (solvent | | C₂ = | Res. |
| | Type | Rate | feed | included) | | conv. | time |
| Sample # | - | g/min | g/min | g/min | wt % | % | min |

Inventive:

| | | | | | | | |
|---|---|---|---|---|---|---|---|
| 26790-170 | n-Hexane | 16.7 | 0.07 | 1.85 | 10.0 | 64.7 | 4.5 |
| 26790-184 | n-Hexane | 17.0 | 0.07 | 1.85 | 9.8 | 31.0 | 4.3 |
| 26790-119 | n-Hexane | 8.7 | 1.30 | 1.35 | 11.9 | 31.9 | 7.1 |
| 26790-120 | n-Hexane | 8.7 | 1.22 | 1.50 | 13.1 | 35.3 | 7.0 |
| 26790-046 | i-Hexane | 8.2 | 0.16 | 1.10 | 11.6 | 95.6 | 8.6 |
| 26790-047 | i-Hexane | 8.2 | 0.20 | 1.10 | 11.6 | 92.4 | 8.2 |

Comparative:

| | | | | | | | |
|---|---|---|---|---|---|---|---|
| 26790-178 | n-Hexane | 16.8 | 0.26 | 1.85 | 9.8 | 93.1 | 4.6 |
| 26790-089 | n-Hexane | 8.7 | 1.30 | 1.77 | 15.0 | 93.0 | 7.5 |
| 26790-107 | n-Hexane | 15.4 | 2.17 | 1.77 | 9.2 | 87.9 | 4.5 |
| 26790-108 | n-Hexane | 4.7 | 1.30 | 0.65 | 9.8 | 88.4 | 13.3 |

TABLE 5C
Ethylene homopolymerization - controlled MWD and LCB

| | Product | | | |
|---|---|---|---|---|
| | | | Mn = (LS | Mw/Mn |
| | | Mw by LS | Mw)/ | by DRI |
| | MI | By GPC | | |
| Sample # | g/10 min | kg/mol | kg/mol | — |

Inventive:

| | | | | |
|---|---|---|---|---|
| 26790-170 | 1.3 | 121.12 | 57.68 | 2.10 |
| 26790-184 | 0.2 | 190.48 | 78.07 | 2.44 |
| 26790-119 | 0.5 | 169.54 | 81.12 | 2.09 |
| 26790-120 | 0.4 | 157.78 | 69.50 | 2.27 |
| 26790-046 | 3.5 | 84.38 | 39.43 | 2.14 |
| 26790-047 | 3.1 | 65.29 | 32.48 | 2.01 |

Comparative:

| | | | | |
|---|---|---|---|---|
| 26790-178 | 37.0 | 39.15 | 18.82 | 2.08 |
| 26790-089 | 39.0 | 38.87 | 17.43 | 2.23 |
| 26790-107 | 78.6 | 34.38 | 15.84 | 2.17 |
| 26790-108 | 30.04 | 30.04 | 12.95 | 2.32 |

TABLE 6A
Ethylene-octene copolymerization - controlled MWD and LCB

| | Catalyst | | | Reactor | |
|---|---|---|---|---|---|
| | Ligand | Metal | Activator | Conditions | |
| | Type | Type | Type | Temp. | Press. |
| Sample # | — | — | — | ° C. | psig |
| 26933-039 | F3 | Hf | D4 | 145.0 | 603 |
| 26933-044 | F3 | Hf | D4 | 15..0 | 1712 |
| 26933-094 | F3 | Zr | D4 | 130.0 | 1731 |

TABLE 6B
Ethylene-octene copolymerization—controlled MWD and LCB

| | Reactor Conditions | | | | | | | |
|---|---|---|---|---|---|---|---|---|
| | | C₂ = feed | | | | HAO feed | | |
| | Solvent | (solvent | | C₂ = feed | | (monomer | | |
| | feed | included) | | (monomer | C₂ = | only) | | Res. |
| | Type | g/ | | only) | conv. | wt | mol | time |
| Sample # | - | min | wt % | mol % | % | % | % | min |
| 26933-039 | i-Hexane | 1.10 | 11.48 | 98.0 | 96.0 | 7.6 | 2.03 | 8.3 |
| 26933-044 | i-Hexane | 1.10 | 11.57 | 99.5 | 95.1 | 2.0 | 0.52 | 8.5 |
| 26933-094 | n-Hexane | 1.20 | 12.13 | 98.5 | 72.8 | 5.6 | 1.5 | 8.4 |

TABLE 6C
Ethylene-octene copolymerization - controlled MWD and LCB

| | Product | | |
|---|---|---|---|
| | Melting | DSC | NMR |
| | Peak | HAO | HAO |
| Sample # | ° C. | mol % | mol % |
| 26933-039 | 111.7 | 1.9 | 1.9 |
| 26933-044 | 118.8 | 0.9 | 0.9 |
| 26933-094 | 126.9 | 0.4 | 0.3 |

### Example 7. Determination of Long-Chain Branching

To determine the degree of LCB formation, two inventive LCB HDPE products, 26933-046 and 26933-047, were also analyzed by ¹³C NMR following the method of L. Hou et al. (2012) Polymer, v.53, pg. 4329. Based on their Mn values, these polymers had about 2,814 and 2,322 C atoms, respectively. This NMR analysis yielded, respectively, 0.54 and 0.60 LCB/1000 C atoms in the polymer. These LCB concentrations correspond to LCB numbers of 1.5 and 1.4 per average polymer chain, respectively. It should be noted that the NMR method used will count all chains that contain more than four carbon atoms. Because of the statistical nature of the macromer incorporation in the currently disclosed process, the LCB chain length varies. Since the shorter LCB fraction is less effective or may even be ineffective in creating shear thinning, the NMR-based LCB count tends to be higher than what can be estimated from rheology data. This is why it is desirable for making the inventive LCB HDPE to have the minimum MW disclosed herein.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I” preceding the recitation of the composition, element, or elements and vice versa, e.g., the terms “comprising,” “consisting essentially of,” “consisting of” also include the product of the combinations of elements listed after the term.

Various modifications and alterations that do not depart from the scope and spirit of this invention will become apparent to those skilled in the art. This invention is not to be duly limited to the illustrative embodiments set forth herein.

What is claimed is:

1. A polymerization process comprising contacting an ethylene feed containing ethylene monomers with a catalyst feed containing a hafnium-based or zirconium-based single-site catalyst in a solution in a reactor so as to polymerize the ethylene monomers into long-chain branched high density polyethylene having on average a long-chain branch/polymer chain less than 10 and greater than 0.25.

2. The process of claim 1, wherein the long-chain branched high density polyethylene has a molecular weight distribution (Mw/Mn) less than 2.5 and greater than 2.0.

3. The process of claim 1, wherein the long-chain branched high density polyethylene has a melt index (MI) less than 30 and greater than 0.1 g/l 0 min.

4. The process of claim 1, wherein the long-chain branched high density polyethylene has a molecular weight greater than 42 kg/mol and less than 750 kg/mol.

5. The process of claim 1, wherein the solution is a single-phase solution.

6. The process of claim 1, wherein the solution is a bi-phasic solution having a polymer lean continuous phase and a polymer rich dispersed phase.

7. The process of claim 1, wherein the single-site catalyst is formed from a catalyst precursor and an activator.

8. The process of claim 7, wherein the single-site catalyst is a metallocene catalyst.

9. The process of claim 8, wherein the catalyst precursor is selected from the group consisting of dimethyl[(dimethylsilylene)bis[(1,2,3,3a,7a-h)-4,5,6,7-tetrahydro-1H-inden-1-ylidene]]-zirconium and dimethyl (μ-di(p-triethylsilylphenyl)silyl)(3,8-di-tert-butylfluorenylindenyl)hafnium, and the activator is selected from the group consisting of dimethylanilinium-tetrakis(perfluorophenyl)borate and dimethylanilinium-tetrakis(heptafluoronaphthyl)borate.

10. The process of claim 1, wherein the reactor has an in-reactor loop flow rate/feed rate that is greater than 4 weight/weight and less than 10.

11. The process of claim 1, wherein ethylene concentration in the reactor feed is between 5 and 40 wt %, based on the total feed stream of the reactor.

12. The process of claim 1, wherein the conversion of the ethylene monomers in the reactor is greater than 25% and less than 98%.

13. The process of claim 1, wherein the solution is at a temperature greater than 110° C. and less than 200° C.

14. The process of claim 1, wherein the solution is at a pressure that is greater than 500 psig (3,400 kPa) and less than 3,000 psig (21,000 kPa).

15. The process of claim 1, wherein the reactor is selected from the group consisting of continuous reactors and boil pool reactors.

16. The process of claim 1, wherein an extensional viscosity response of the long-chain branched high density polyethylene shows strain hardening.

17. The process of claim 1, wherein the solution is a single-phase solution, wherein the long-chain branched high density polyethylene has a molecular weight distribution less than 2.5 and greater than 2.0, a melt index (MI) less than 30 and greater than 0.1 g/10 min, and a molecular weight greater than 42 kg/mol and less than 750 kg/mol, wherein the single-site catalyst is formed from a catalyst precursor and an activator, wherein the single-site catalyst is a metallocene catalyst, wherein the catalyst precursor is selected from the group consisting of dimethyl[(dimethylsilylene)bis[(1,2,3,3a,7a-h)-4,5,6,7-tetrahydro-1H-inden-1-ylidene]]-zirconium and dimethyl (μ-di(p-triethylsilylphenyl)silyl)(3,8-di-tert-butylfluorenylindenyl)hafniumn, and the activator is selected from the group consisting of dimethylanilinium-tetrakis(perfluorophenyl)borate and dimethylanilinium-tetrakis(heptafluoronaphthyl)borate, wherein the reactor has an in-reactor loop flow rate/feed rate is greater than 4 weight/weight and less than 10, wherein ethylene concentration in the reactor feed is between 5 and 40 wt % based on the total feed stream of the reactor, wherein the conversion of the ethylene monomers in the reactor is greater than 25% and less than 98%, wherein the solution is at a temperature greater than 110° C. and less than 200° C., wherein the solution is at a pressure is greater than 500 psig (3,400 kPa) and less than 3,000 psig (21,000 kPa), wherein the reactor is selected from the group consisting of continuous reactors and boil pool reactors, and wherein an extensional viscosity response of the long-chain branched high density polyethylene shows strain hardening.

18. The process of claim 1, wherein the solution is a bi-phasic solution having a polymer lean continuous phase and a polymer rich dispersed phase, wherein the long-chain branched high density polyethylene has a molecular weight distribution less than 2.5 and greater than 2.0, a melt index (MI) less than 30 and greater than 0.1 g/10 min, and a molecular weight greater than 42 kg/mol and less than 750 kg/mol, wherein the single-site catalyst is formed from a catalyst precursor and an activator, wherein the single-site catalyst is a metallocene catalyst, wherein the catalyst precursor is selected from the group consisting of dimethyl[(dimethylsilylene)bis[(1,2,3,3a,7a-h)-4,5,6,7-tetrahydro-1H-inden-I-ylidene]]-zirconium and dimethyl (μ-di(p-triethylsilylphenyl)silyl)(3,8-di-tert-butylfluorenylindenyl)hafnium, and the activator is selected from the group consisting of dimethylanilinium-tetrakis(perfluorophenyl)borate and dimethylanilinium-tetrakis(heptafluoronaphthyl)borate, wherein the reactor has an in-reactor loop flow rate/feed rate is greater than 4 weight/weight and less than 10, wherein ethylene concentration in the reactor feed is between 5 and 40 wt % based on the total feed stream of the reactor, wherein the conversion of the ethylene monomers in the reactor is greater than 25% and less than 98%, wherein the solution is at a temperature greater than 110° C. and less than 200° C., wherein the solution is at a pressure is greater than 500 psig (3,400 kPa) and less than 3,000 psig (21,000 kPa), wherein the reactor is selected from the group consisting of continuous reactors and boil pool reactors, and wherein an extensional viscosity response of the long-chain branched high density polyethylene shows strain hardening.

19. A process for preparing an ethylene-based polyolefin, the process comprising:
maintaining a polymerization mixture at a temperature at or above the lower critical phase separation temperature of the polymerization mixture, while maintaining the polymerization mixture at steady state, where the polymerization mixture is substantially uniform in temperature, pressure, and concentration, where the polymerization mixture includes solvent, monomer including ethylene and optionally monomer copolymerizable with ethylene, a single-site catalyst system, and polymer resulting from the polymerization of the monomer, where the monomer and the polymer are dissolved in the solvent, and where the polymer is an ethylene-based polyolefin having a molecular weight distribution (Mw/Mn) of less than 2.50 and greater than 2.0 and having long-chain branching wherein on average a long-chain branch/polymer chain less than 10 and greater than 0.25.

20. A polymerization composition, comprising:
ethylene;
a hafnium-based or zirconium-based single-site catalyst; and
a long-chain branched high density polyethylene polymerization product, wherein the long-chain branched high density polyethylene has on average a long-chain branch/polymer chain less than 10 and greater than 0.25; and
wherein at least one of the ethylene, the catalyst, and the product is in solution.
